(19) United States
(12) Patent Application Publication
(10) Pub. No.: US 2011/0029322 A1
(43) Pub. Date: Feb. 3, 2011

(54) HEALTH CARE SYSTEM

(75) Inventors: Walid A. Hindo, Northbrook, IL (US); Subbu Ravi, Fitchburg, WI (US)

Correspondence Address: FOLEY & LARDNER LLP, 777 EAST WISCONSIN AVENUE, MILWAUKEE, WI, 53202-5306, US

(73) Assignee: Dr. Walid Hindo

(21) Appl. No.: 12/847,946

(22) Filed: Jul. 30, 2010

Related U.S. Application Data
(63) Continuation-in-part of application No. 12/595,204, now abandoned.
(60) Provisional application No. 61/302,843, filed on Feb. 9, 2010.
(60) Provisional application No. 60/911,241, filed on Apr. 11, 2007.

(51) Int. Cl. G06Q 50/00; G06Q 10/00

(52) U.S. Cl. 705/2

(57) ABSTRACT

An automated system for determining authorization or denial of payment for a medical technique or process includes a user interface configured to receive data related to patient symptoms and diagnosis information, a database configured to store data related to patient symptoms and diagnosis information, and a processor configured to automatically determine authorization or denial of the medical technique or process based on data related to patient symptoms and diagnosis information. The data related to patient symptoms and diagnosis information is received from at least one of the user interface and the database. The processor is configured to provide an indication of authorization or denial to the user interface.

### CROSS-REFERENCE TO RELATED PATENT APPLICATIONS

This application is a continuation-in-part of U.S. National Stage application Ser. No. 12/595,204, filed Oct. 8, 2009, entitled “Method And System For Establishing Electronic Medical Record Treatment Plan,” which claims the benefit of and priority to PCT Application No. PCT/US2008/059656, filed Apr. 8, 2008, entitled “Method And System For Establishing Electronic Medical Record Treatment Plan,” which claims the benefit of and priority to U.S. Provisional Patent Application Ser. No. 60/911,241, filed Apr. 11, 2007, entitled “Method And System For Establishing Electronic Medical Record Treatment Plan,” which are hereby expressly incorporated by reference in their entirety including all exhibits. This application also claims the benefit of and priority to Provisional U.S. Patent Application 61/302,843, filed Feb. 9, 2010, entitled “Health Care System,” which is hereby expressly incorporated by reference in its entirety including all exhibits.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present disclosure relates generally to the field of electronic medical records. The disclosure more particularly relates to a method of generating a medical diagnosis and/or treatment plan based on electronic medical records. The present disclosure also relates generally to the field of medical techniques and processes and automated authorization of those techniques and processes. In one embodiment, the techniques and processes can be techniques and processes used for diagnosis or treatment. In another embodiment, the techniques and processes can be techniques and processes used for testing.

Medical diagnosis and treatment of patients have traditionally been performed by medical professionals based on personal knowledge or a written record (e.g., a medical reference text) of what may be causing various symptoms in the patient and how to remedy the symptoms and/or the cause, which leaves room for error by the medical professional. “Statistically about 80% of the medical mistakes are the result of predictable mental traps, or cognitive errors, that bedevil all human beings. Only 20% are due to technical mishaps—mixed-up test results or hard-to-decipher hand-writing—that typically loom larger in patient's minds and on television shows.” (“Where Doctors Go Wrong,” Time Magazine, Mar. 26, 2007). As computer systems became more common, this medical knowledge as well as patient medical records gradually were transferred to computers as centralized access points. Computer systems also allow for standardized communication of medical information and patient records over networks, such as the Internet, using protocols such as Current Procedural Technology (CPT®), International Classification of Diseases (ICD-9), or Health Level Seven® (HL7). Computer programs have been written that are intended to aid medical professionals in the diagnosis and/or treatment of patients by analyzing the symptoms and/or or medical history of a patient, however these systems tend to provide false diagnoses, for example due to a lack of relevant information, low cost effectiveness, or lack of a comprehensive treatment plan. Other systems may require the medical professional to form a hypothesis and later verify the hypothesis with evaluation and testing, however if the original hypothesis is wrong, the process must be started over. Many of these systems do not facilitate information exchange within a computer network to improve medical document efficiency or to provide updates to the diagnosis software. Other systems may only be configured for use by a single type of user, for example a doctor, while not providing access to other types of users, such as the patient.

Therefore, there is a need for an improved medical diagnosis and treatment plan system and method capable of generating medical diagnoses and treatment plans with more accuracy, increased cost effectiveness, and a more comprehensive treatment plan. There is also a need for a medical diagnosis and treatment plan system and method capable of managing patient records in a standard format to facilitate information exchange of medical and system information.

Medical and diagnostic processes or techniques include medical tests, such as medical imaging. Medical imaging refers to the techniques and processes used to create images of the human body (or parts thereof) for clinical purposes (e.g., medical procedures seeking to reveal, diagnose or examine disease) or medical science (e.g., including the study of normal anatomy and function). Some of the processes/techniques may include radiology, radiological sciences, endoscopy, thermography, medical photography and microscopy, electroencephalography (EEG), magnetoencephalography (MEG), magnetic resonance imaging (MRI), nuclear imaging, tomography, and fluoroscopy.

Currently, Medical imaging accounts for a large portion of overall healthcare spending. Radiology costs in the United States are more than $100 billion annually and diagnostic imaging is the second-largest and fastest-growing expense for health plans behind pharmaceuticals. Unmanaged, radiology spending may continue growing at a rate of about 20% annually. According to the American College of Radiologists (ACR), imaging technologies are a $100 billion industry, increasing at three times the rate of overall physician services and making it the fastest growing type of physician service expenditure in the United States.

The medical necessity of at least some of these procedures is questionable, for example, over 40% of the imaging procedures that the physician offices request may not be medically necessary. Furthermore, the Center for Information Technology Leadership at Harvard University (CITL) estimates that about 20% of hospital radiology tests are duplicates, which represents approximately wasted spending of $20 billion a year nationwide.

To counter the growing expenditure, payors often turn to utilization management and pre-authorization companies for cost containment. These companies typically have utilization guidelines and medical necessity guidelines for imaging procedures that are maintained by the American College of Radiology. Generic utilization management and pre-authorization companies may use conventional software, however conventional software solutions have not implemented the radiology guidelines. These guidelines are available free in the public domain and most cost containment activities are performed manually.

What is needed is a system and method for reducing the number of medically unnecessary radiology tests. What is also needed is a system and method for reducing the number of duplicate radiology tests. What is further needed is a system and method for automating implementation of radiology guidelines.

### SUMMARY

According to one exemplary embodiment, an automated system for determining authorization or denial of payment for a medical technique or process includes a user interface configured to receive data related to patient symptoms and diagnosis information, a database configured to store data related to patient symptoms and diagnosis information, and a processor configured to automatically determine authorization or denial of the medical technique or process based on data related to patient symptoms and diagnosis information. The data related to patient symptoms and diagnosis information is received from at least one of the user interface and the database. The processor is configured to provide an indication of authorization or denial to the user interface.

According to another exemplary embodiment, an automated method for determining authorization or denial of payment for a medical technique or process includes receiving data related to patient symptoms and diagnosis information at a user interface, storing data related to patient symptoms and diagnosis information on a database, and automatically determining authorization or denial of the medical technique or process based on data related to patient symptoms and diagnosis information using a processor. The data is related to patient symptoms and diagnosis information being received from at least one of the user interface and the database. The method also provides an indication of authorization or denial from the processor to the user interface.

According to another exemplary embodiment, an automated system for determining authorization or denial of payment for a medical technique or process includes means for receiving data related to patient symptoms and diagnosis information, means for storing data related to patient symptoms and diagnosis information, and means for automatically determining authorization or denial of the medical technique or process based on data related to patient symptoms and diagnosis information. The data is related to patient symptoms and diagnosis information being received from at least one of the user interface and the database. The system also includes means for providing an indication of authorization or denial.

Another exemplary embodiment relates to an apparatus for generating a medical diagnosis or treatment plan includes a computing system, a user interface, a network, a database, and a server. The server is configured to provide a diagnosis and recommended treatment plan based on one or more symptoms, a physical examination, and a laboratory and/or imaging test.

Another exemplary embodiment relates to a method on a computer-readable medium for generating a medical diagnosis and/or treatment plan. The method includes the steps of identifying a symptom, ordering a suggested laboratory or imaging test, recording a result of said test, generating a diagnosis based on said symptom, said laboratory and/or imaging test, and generating a treatment plan based on said diagnosis.

Another exemplary embodiment relates to an apparatus for managing patient medical records and generating a medical diagnosis and/or treatment plan. The apparatus includes means for identifying a symptom, means for ordering a suggested laboratory and/or imaging test, means for recording a result of said test, means for generating a diagnosis based on said symptom, said laboratory and/or imaging test, and means for generating a treatment plan based on said diagnosis.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present disclosure will become apparent from the following description, appended claims, and the accompanying exemplary embodiments shown in the drawings, which are briefly described below.

FIG. 1 is a block diagram of a medical records and treatment plan system according to one exemplary embodiment.

FIG. 2 is a process flow diagram illustrating a process for maintaining medical records and generating a patient diagnosis and treatment plan with in the system of FIG. 1, according to one exemplary embodiment.

FIG. 3 is a process flow diagram illustrating details of the method of FIG. 2, according to two exemplary embodiments.

FIG. 4 is a process flow diagram illustrating details of the diagnosis and treatment plan method of FIG. 2, according to one exemplary embodiment.

FIG. 5 is a process flow diagram illustrating decision logic used to find a medical diagnosis in the method of FIG. 4, according to one exemplary embodiment.

FIG. 6 is a process flow diagram illustrating the process for managing electronic medical records in the method of FIG. 2, according to one exemplary embodiment.

FIG. 7 is a schematic diagram illustrating entities that may communicate with or access a medical record of a user via the system of FIG. 1, according to one exemplary embodiment.

FIG. 8 is a schematic diagram illustrating a user interaction in an assessment process of the system of FIG. 1, according to one exemplary embodiment.

FIG. 9 is a schematic diagram illustrating administrator management of the system of FIG. 1, according to one exemplary embodiment.

FIG. 10 is a process flow diagram illustrating administrator management of the system of FIG. 1, according to one exemplary embodiment.

FIG. 11 is a schematic diagram illustrating user interaction in a patient management process of the system of FIG. 1, according to one exemplary embodiment.

FIG. 12 is a schematic diagram illustrating user interaction in a treatment plan communication process of the system of FIG. 1, according to one exemplary embodiment.

FIG. 13 is a schematic diagram illustrating agent interaction in a patient management process of the system of FIG. 1, according to one exemplary embodiment.

FIG. 14 is a schematic diagram illustrating customer interaction in a subscription management process of the system of FIG. 1, according to one exemplary embodiment.

FIG. 15 is a schematic diagram illustrating administrator interaction in a CPT management process of the system of FIG. 1, according to one exemplary embodiment.

FIG. 16 is a schematic diagram illustrating administrator interaction in an ICD-9 management process of the system of FIG. 1, according to one exemplary embodiment.

FIG. 17 is a schematic diagram illustrating administrator interaction in a treatment plan management process of the system of FIG. 1, according to one exemplary embodiment.

FIG. 18 is a computer screenshot of a patient management page in the system of FIG. 1, according to one exemplary embodiment.

FIG. 19 is a computer screenshot of a symptom page in the system of FIG. 1, according to one exemplary embodiment.

FIG. 20 is a computer screenshot of a diagnosis page in the system of FIG. 1, according to one exemplary embodiment.

FIG. 21 is a computer screenshot of a treatment plan page in the system of FIG. 1, according to one exemplary embodiment.

FIG. 22 is a computer screenshot of a patient history page in the system of FIG. 1, according to one exemplary embodiment.

FIG. 23 is a computer screenshot of a services provided summary page in the system of FIG. 1, according to one exemplary embodiment.

FIG. 24 is a computer screenshot of a patient summary page in the system of FIG. 1, according to one exemplary embodiment.

FIG. 25 is a flow diagram showing a cost containment hierarchy according to an exemplary embodiment.

FIG. 26 is a flow diagram showing a healthcare system or method according to an exemplary embodiment.

FIG. 27 is a flow diagram showing a healthcare system or method according to another exemplary embodiment.

FIG. 28 is a block diagram showing a system for executing a patient diagnosis or testing method according to an exemplary embodiment.

FIGS. 29-36 are screenshots showing a various interface screens of a healthcare system or method according to an exemplary embodiment.

FIG. 37 illustrates a decision tree for use by the system of FIG. 28 according to an exemplary embodiment.

### DETAILED DESCRIPTION

### Diagnosis/Treatment Management

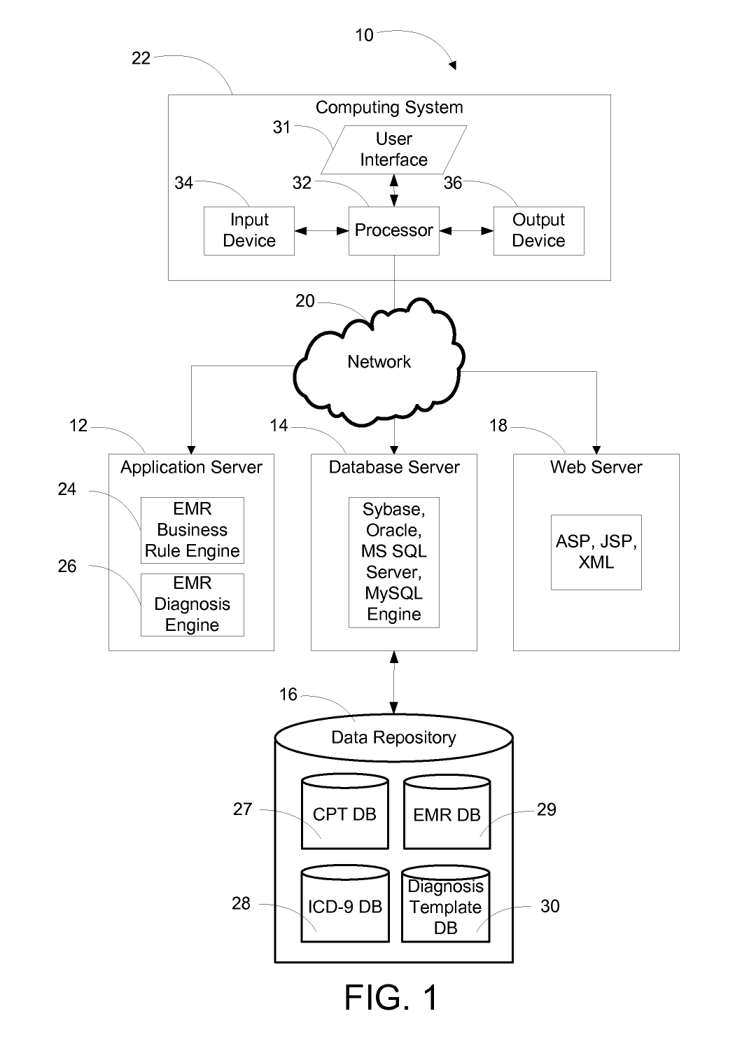

Referring to FIG. 1, a system 10 is configured to manage the diagnosis and/or treatment provided to a patient. In one embodiment, system 10 can be configured to provide a patient electronic medical record (EMR) operation, provide a patient diagnosis information operation, and provide a patient treatment plan operation. System 10 generally includes an application server 12, a database server 14, a data repository 16, a web server 18, a network 20, and a computing system 22.

Application server 12 is configured to provide and receive information related to medical records and medical diagnosis and treatment to and from a user of computing system 22. Server 12 typically includes an EMR business rule engine 24 and a diagnostic and treatment engine 30. EMR business rule engine 24 is configured to add patient EMRs to database server 14, manage or edit existing EMRs in EMR database server 14, and retrieve and send EMR information using predefined business rules as requested by a user. EMR business rule engine 24 communicates with data repository 16 so that patient EMRs conforms to medical documentation standards and may be usable with other medical systems. Application server 12 may be of any past, present, or future technology that is capable performing logical operations related to medical information.

EMR diagnosis engine 26 is configured to use existing EMRs, user inputs and/or other EMR systems to provide a medical diagnosis and/or treatment plan to the user. The diagnosis or treatment plan may be generated by EMR diagnosis engine 26 based on Gender, Age, Symptom, Physical Exam, Lab Procedure, Image, other medication information, or any combination thereof, that is used in decision logic to determine the diagnosis and treatment plan. EMR diagnosis engine 26 may also communicate with data repository 16 so that medical diagnosis and treatment information conforms with medical documentation standards that may be saved in an EMR and may be usable with other medical systems.

Database server 14 is configured to interface with data repository 16 in order to manage EMRs, diagnosis templates, disease classifications, and procedural terminology. According to various exemplary embodiments, database server 14 generally interfaces with data repository 16 using a database programming language, for example Sybase®, Oracle®, MS SQL Server®, MySQL Engine®, another language, or any combination thereof.

Data repository 16 is configured to store data used by system 10 through database server 14. According to one exemplary embodiment, data repository 16 may be located on database server 14. According to another exemplary embodiment, data repository 16 may be located remotely from and in communication with database server 14. Data repository 16 includes a CPT® database 28 (i.e., to store procedural terminology), an ICD-9® database 30 (i.e., to store disease classifications), an EMR database 32 (i.e., to store patient medical records), and a diagnosis template database 34. Diagnosis template database 30 is typically configured to store the relations between elements of the diagnosis algorithm, for example with a number of data tables. Diagnosis template database 30 defines the relationships between EMRs, symptoms, physical exams, laboratory tests, diagnoses, and treatment plans together.

Web server 18 is configured to provide a world-wide-web page to computing system 22 based on information from application server 12 and database server 14. According to various exemplary embodiments, web server 18 may provide Active Server Pages (ASP™), JavaServer Pages (JSP™), any other type of webpage, or any combination thereof. According to various exemplary embodiments, web server 18 may provide a webpage using Extensible Markup Language (XML), HyperText Markup Language (HTML), any other type of a programming or scripting language, or any combination thereof.

Network 20 is configured to facilitate communication (e.g., EMR information, diagnosis information, treatment plan information, etc.) application server 12, database server 14, web server 18, and computing system 22. Network 20 may be a wired or wireless network, for example, a LAN, WAN, the Internet, or any other network that is capable of facilitating communication between application server 12, database server 14, web server 18, and computing system 22. Communication with the network may be achieved via IEEE 802.11 Wi-Fi, IEEE 802.3 Ethernet, or modulate and demodulate (modem) technologies, or any other suitable communication technology.

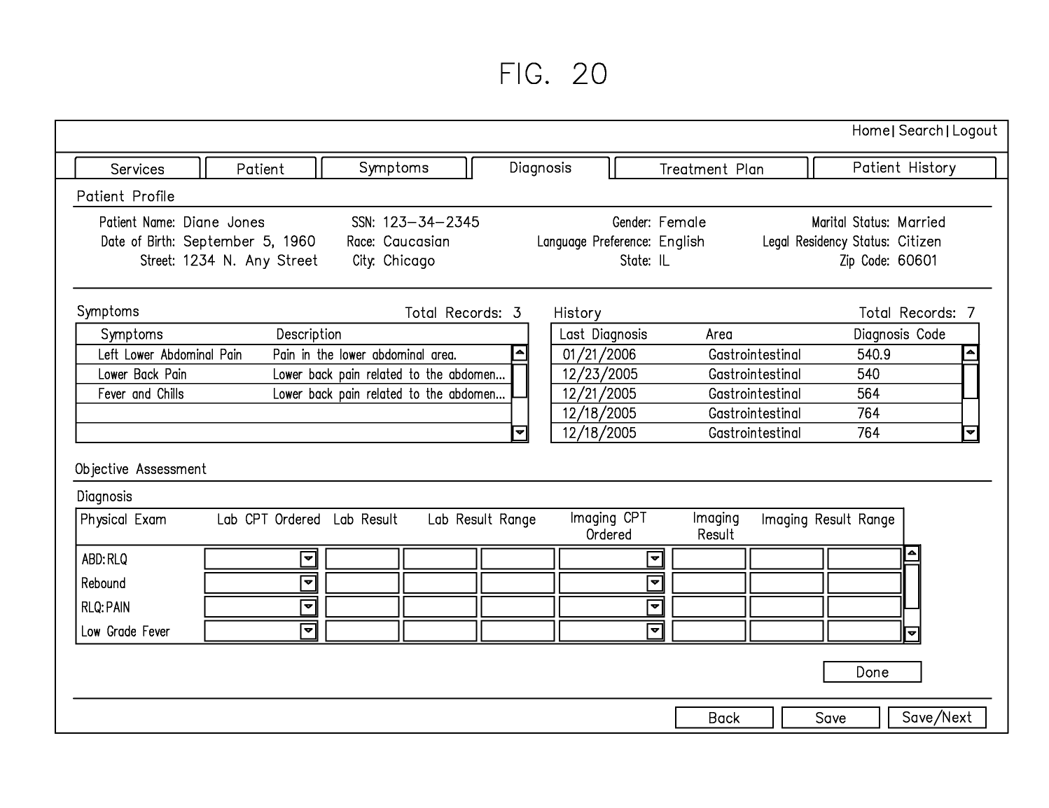

Computing system 22 is configured to interact with application server 12, database server 14, and web server 18 so that the user may retrieve and manage EMRs and diagnosis or treatment plan information. Computing system 22 may include a user interface 31, a processor 32, an input device 34, and an output device 36. User interface 22 is configured to provide a graphical and interactive screen to facilitate user interaction between computing system 22, application server 12, database server 14, and web server 18 (e.g., see FIG. 18-23). According to various exemplary embodiments, user interface 22 may be embodied on computing system 22, on application server 12, or a removable medium such as a disk or CD-ROM. Processor 32 may be any processor capable of past, present or future design that is capable of receiving input, providing output, and communicating with server 12. Input device 34 may include a keyboard, a mouse, a light pen, a track pad, a disk drive, a voice interface, or any other suitable computer input device or combination thereof. Output device may include a monitor, a printer, a speaker, a disk drive, or any other suitable computer output or combination thereof.

While system 10 is shown to include four remote systems in communication with each other, it is noted that in other exemplary embodiments, computing system 22, application server 12, database server 14, and web server 18 may be integrated into a single computing system or multiple nodes of computers performing the role specified by application server 12, database server 14, and web server 18.

In another exemplary embodiment, multiple computing systems may be included to facilitate user interaction from multiple locations or by multiple users. In other exemplary embodiment, additional servers may be included to provide data backup, distributed processing, etc. In still other exemplary embodiments, multiple computing systems and additional servers may be used.

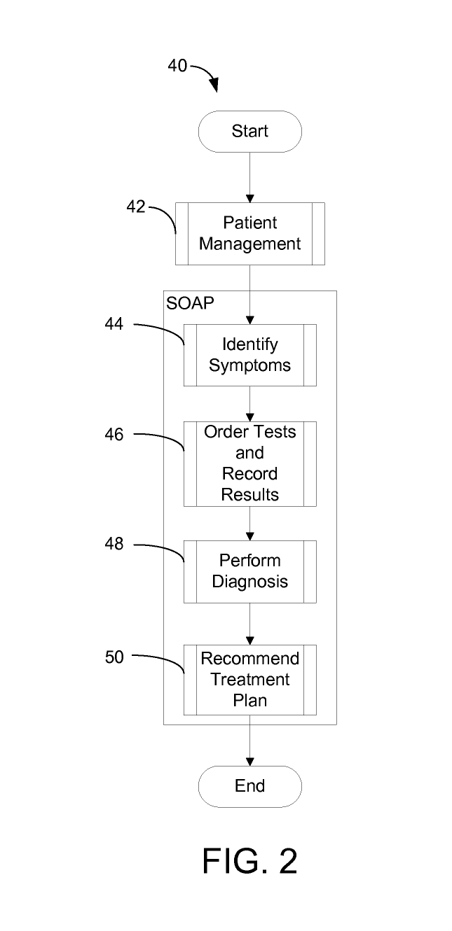

Referring to FIG. 2, a method 40 is configured to manage patient EMRs and generate a Subjective Objective Assessment Plan (SOAP); a medical diagnosis and treatment plan. At a step 42, system 10 performs a patient management process. Patient EMRs may be added, updated/edited, or deleted. At a step 44, system 10 performs a symptom identification process. Based on inputs by a patient, medical professional, or from data extracted from an EMR, system 10 may identify symptoms. At a step 46, system 10 recommends medical tests, procedures, or exams and records the results of the tests or procedures once performed by a medical professional. At a step 48, system 10 generates a diagnosis based on one or more patient EMRs, identified symptoms from step 44, and/or test results recorded at step 46. At step 50, system 10 recommends a treatment plan based on the diagnosis generated at step 48 and any applicable information from a patient EMR (e.g., medications, risk factors, etc.).

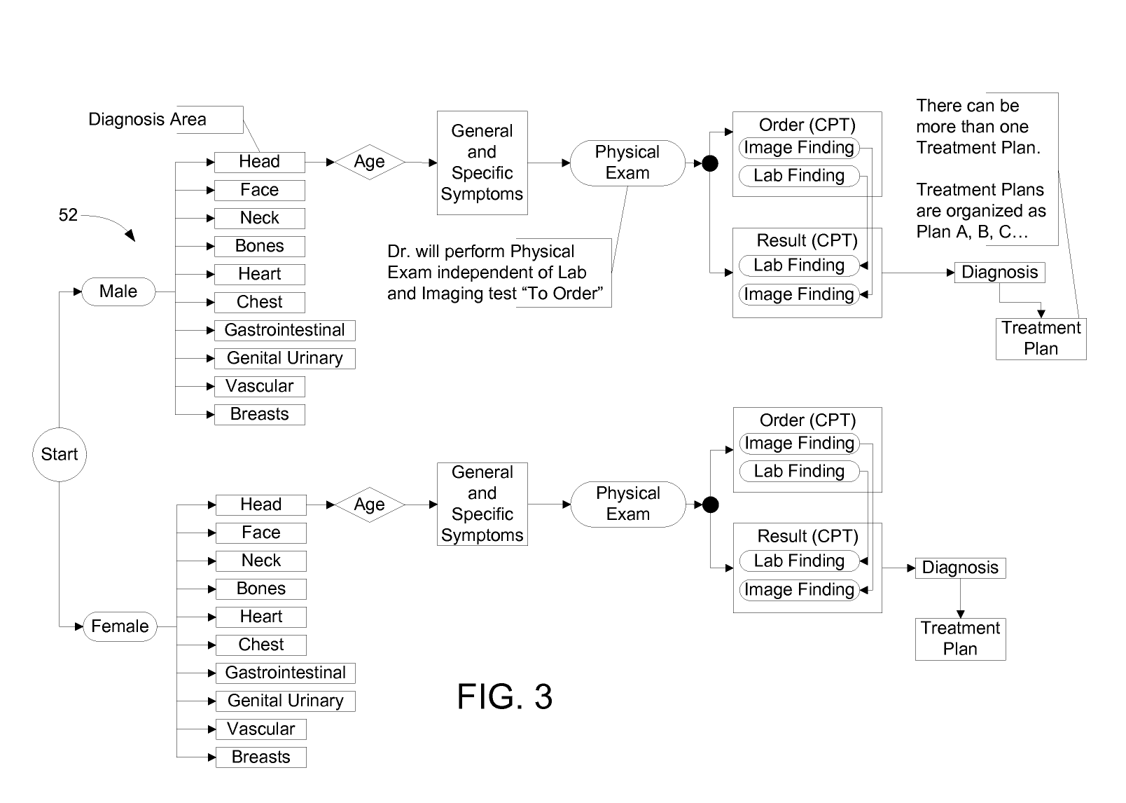

Referring to FIG. 3, further details of two exemplary embodiments of the method of FIG. 2 are shown. A process flow 52 illustrates that prior to the identification of symptoms, gender, concern or history of a diagnosis area (i.e., head, face, neck, bones, heart, chest, gastrointestinal, genital urinary, vascular, and breasts), and age are factored into the diagnosis and treatment plan generated. These additional factors may be extracted from an EMR or entered by the patient or a medical professional. Once symptoms have been identified, a medical professional performs a physical exam independent of lab and/or imaging test orders. The results (i.e., a lab or image finding and the physical exam) are recorded, which factors in to the diagnosis and treatment plan(s) system 10 generates.

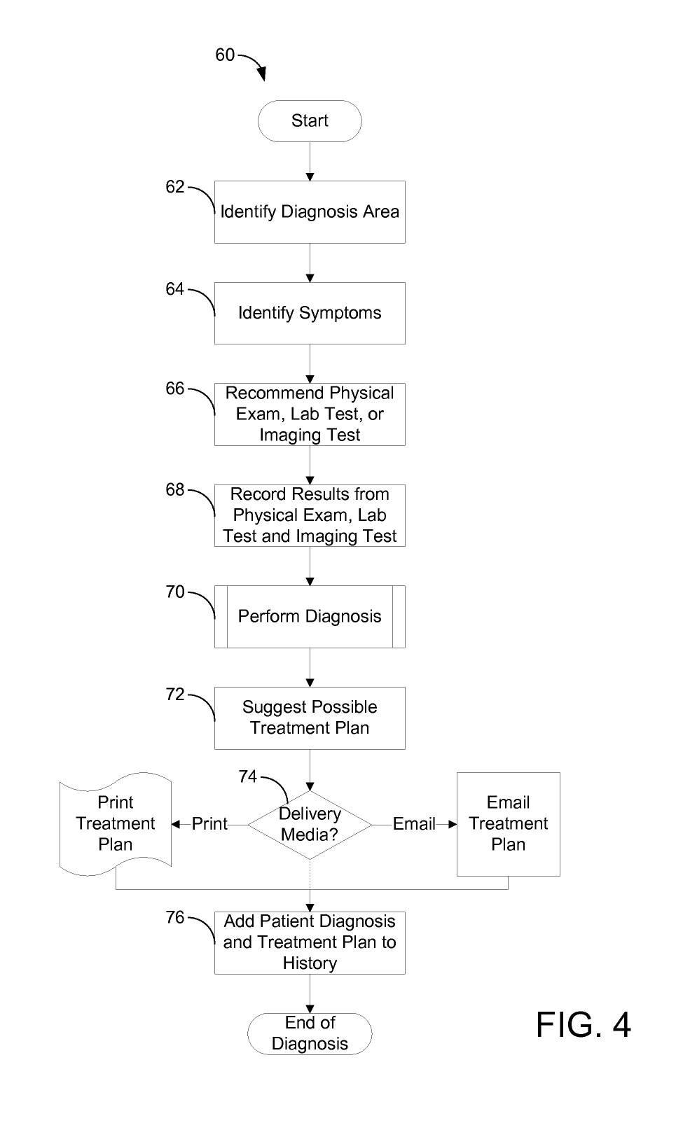

Referring to FIG. 4, a method 60 includes a number of steps that may be taken in system 10 to generate and use a diagnosis and treatment plan. At a step 62, a diagnosis area is identified based on an EMR, history, or area of patient or medical professional concern. At a step 64, symptoms (e.g., major symptoms, specific symptoms, etc.) are selected on system 10, for example manually entered by a medical professional or patient. At a step 66, system 10 recommends a physical exam, lab test, and/or imaging test. At a step 68, system 10 records the results of the physical exam, lab test, and imaging test of step 66. At a step 70, system 10 performs or generates a diagnosis based on the diagnosis area, symptoms, physical exam, lab test, and/or imaging test. At step 72, system 10 suggests a possible treatment plan based on the diagnosis and patient information (e.g., medications, risk factors, etc.). At a step 74, system 10 delivers the treatment plan, for example by printing and/or emailing, to the patient, medical professional, and or insurance company. At a step 76, system 10 adds the patient diagnosis and treatment plan to the patient history or EMR.

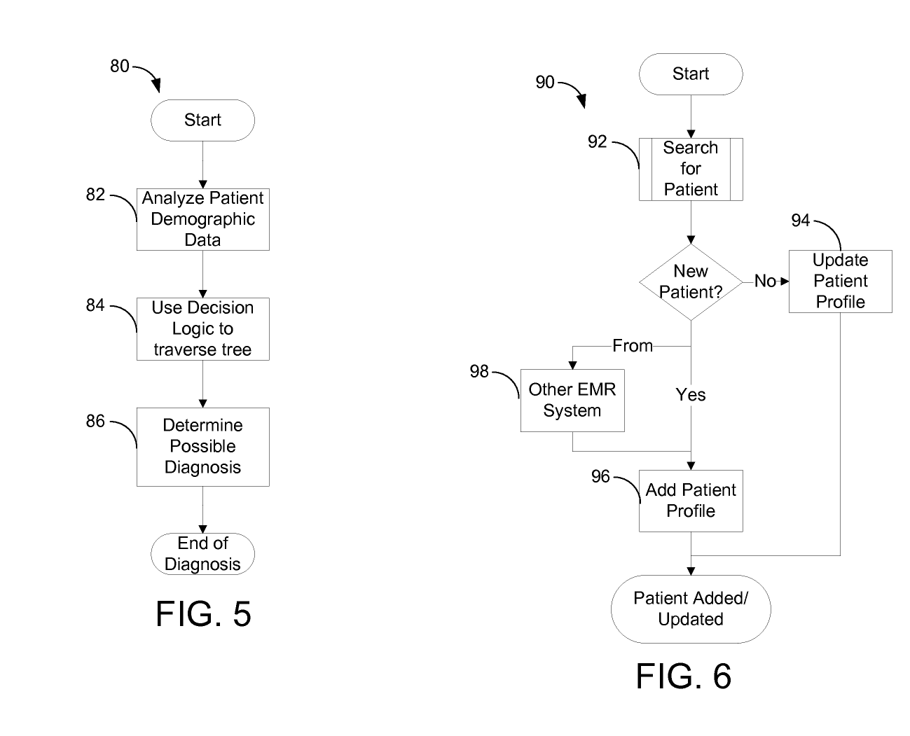

Referring to FIG. 5, a method 80 determines a medical diagnosis used in step 70 of method 60. At a step 82, system 10 analyzes demographic data related to a patient from the patient EMR or from information entered manually. At a step 84, system 10 uses decision logic to traverse a diagnosis tree based on patient demographic data, symptoms, physical exam results, lab test results, and/or imaging results. At a step 86, system 10 determines one or more possible diagnoses based on the diagnosis tree traversal. According to various exemplary embodiments, the decision logic and diagnosis tree may be of any past, present, or future design that is capable of providing a diagnosis based on patient demographic data, symptoms, physical exam results, lab test results, and/or imaging results.

Referring to FIG. 6, a method 80 manages patient EMRs on system 10. At a step 82, system 10 searches for a patient based on user inputs (e.g., name, social security number, etc.). If the patient is not new, the patient profile may be retrieved and updated at step 84. If the patient is new, a patient profile is added at step 86 using information from other EMR systems at step 88, if available.

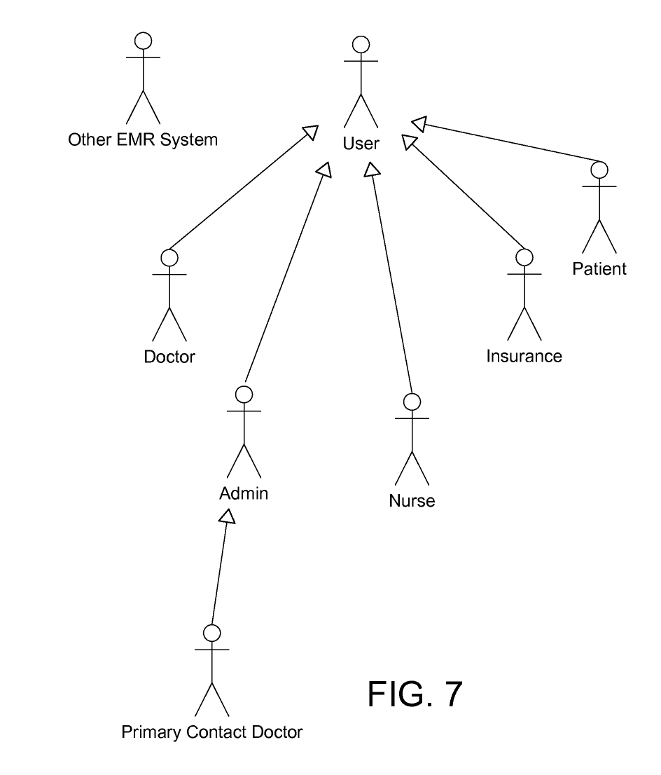

Referring to FIG. 7, system 10 may include a number of different types of users. A patient may have access to personal diagnosis and treatment information as well as personal EMRs. An insurance company may have access to various information in a patient EMR, for example billing information, diagnosis information, procedures ordered, and/or procedures performed. A nurse may have access to the EMRs of various patients for use in treatment, for documentation of test results, etc. A doctor may similarly have access to the EMRs of various patients as well as be able to confirm and prescribe diagnoses, treatment plans, and medications. A primary contact doctor may have full access to all of the aspects of system 10 so that he or she may act as a source of information, troubleshooter, administrator, etc.

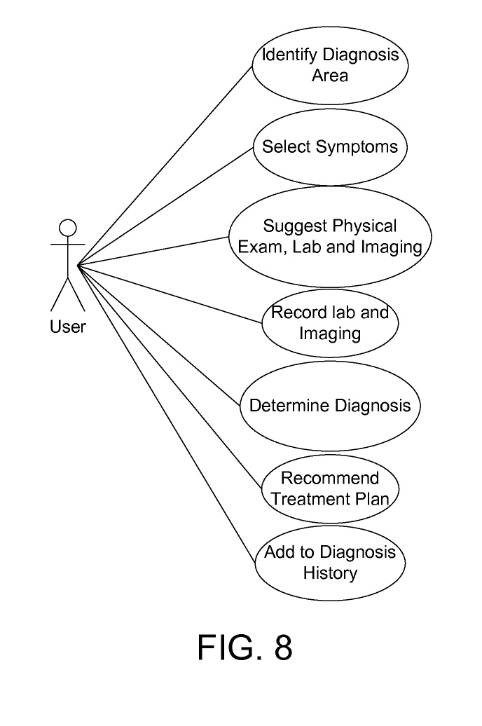

Referring to FIG. 8, a further characterization is given of the interaction between a user (e.g., a patient, doctor, nurse, insurance company, etc.) and system 10 following a diagnosis and treatment plan process similar to those of FIG. 2-4.

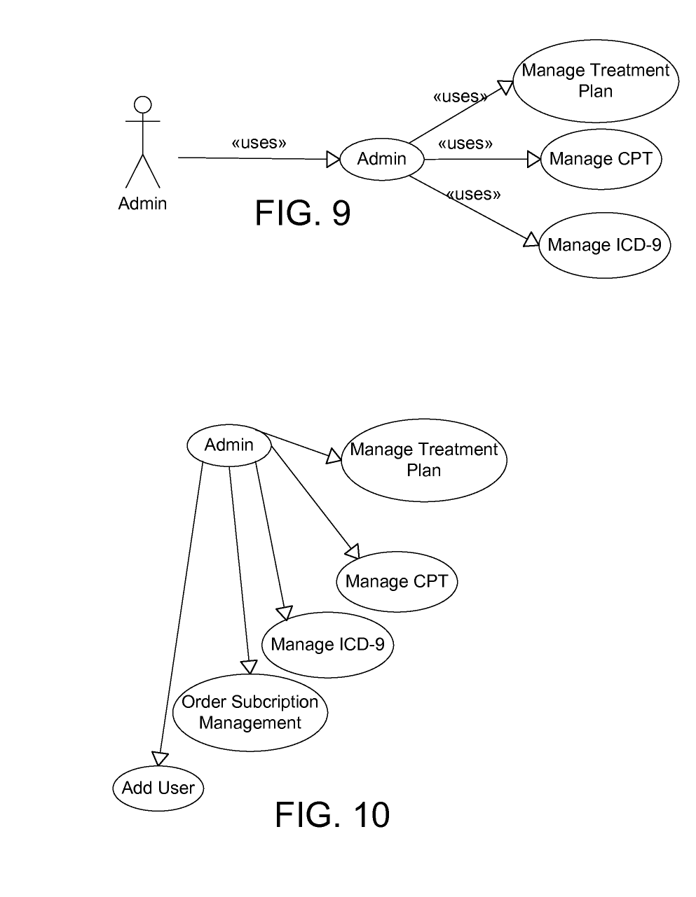

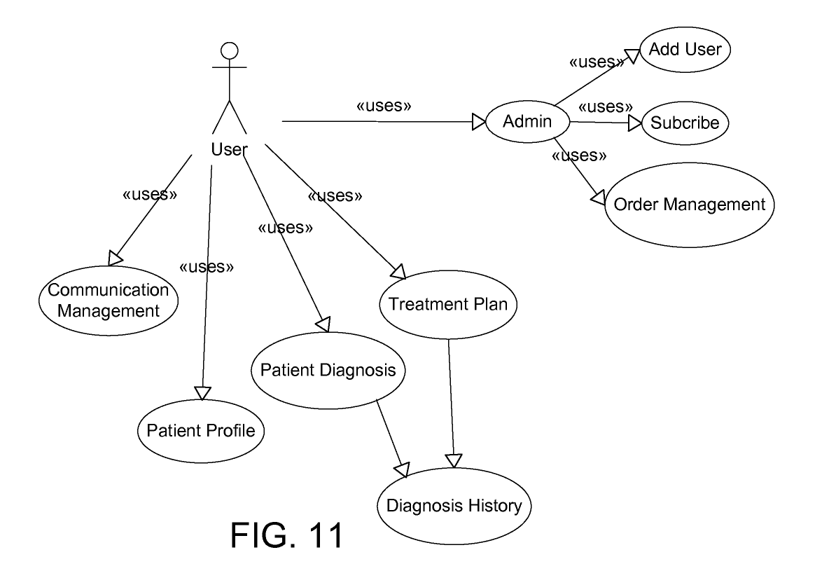

Referring to FIGS. 9-11, a user with administrator access rights has the ability to manage various aspects of system 10 including patient treatment plans, terminology database 18, and disease classification database 20, order subscriptions, and user addition. Management of a patient treatment plan may include verification or override of a diagnosis or plan suggested by system 10, an update in the logic used by EMR diagnosis engine 26, or any other function related to treatment plan management. Management of terminology database 18 may include updating a CPT® version, or any other function related to terminology management (see FIG. 15). Similarly, management of disease classification database 20 may include updating an ICD-9 version, or any other function related to disease classification management (see FIG. 16). Management of order subscriptions may include verification or editing of lab procedures, for example. In addition to administrative tasks, an administrator may also perform general diagnosis, treatment, and EMR tasks, for example as a doctor may perform.

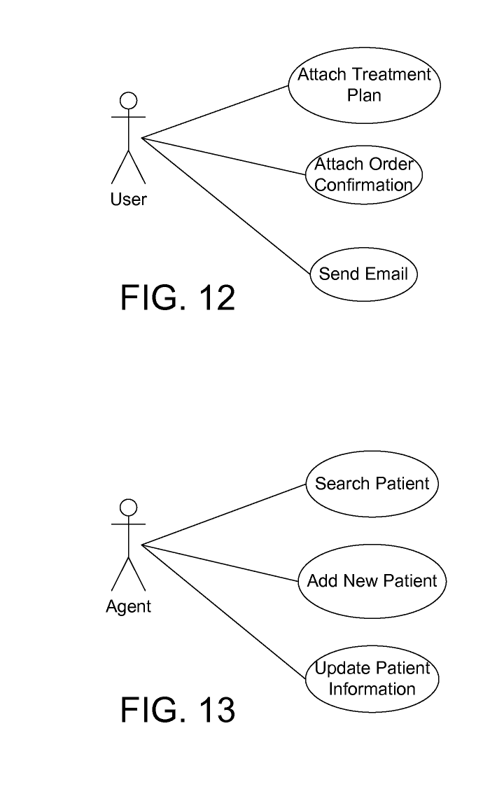

Referring to FIG. 12, any user (e.g., doctor, nurse, patient, agent, etc.) may use system 10 to send an e-mail including an attached treatment plan and order confirmation. According to one exemplary embodiment, the email may be sent to other users, for example from a patient to an insurance company.

Referring to FIG. 13, an agent, for example from an insurance company, may use system 10 to search for patients, add new patients, update patient information. An insurance agent may wish to use the patient information internally for procedure approval, proper diagnosis, and/or proper coding.

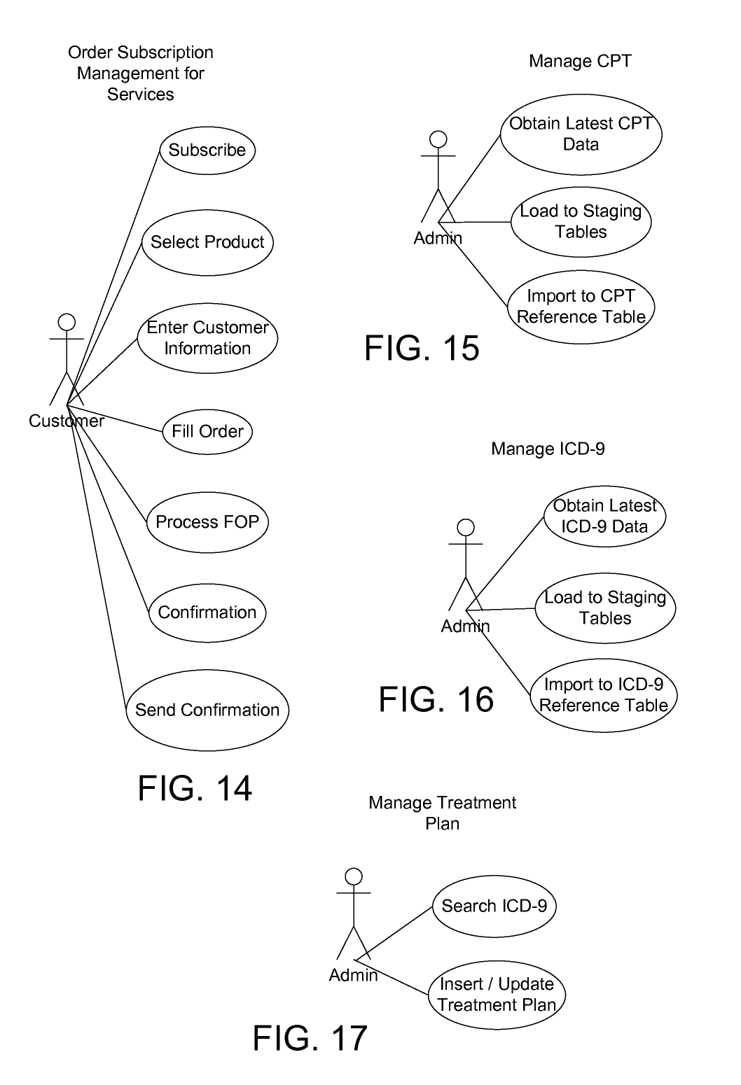

Referring to FIG. 14, a customer or user may manipulate system 10 to manage order subscriptions. Order subscription typically includes product selection (e.g., type of lab test) and submission of customer information (e.g., name, insurance information, etc.). Once the order is filled, a forecast for procurement (FOP) is processed. Once the FOP is confirmed, the confirmation is sent, for example to the medical records, to the insurance company, to the patient, etc.

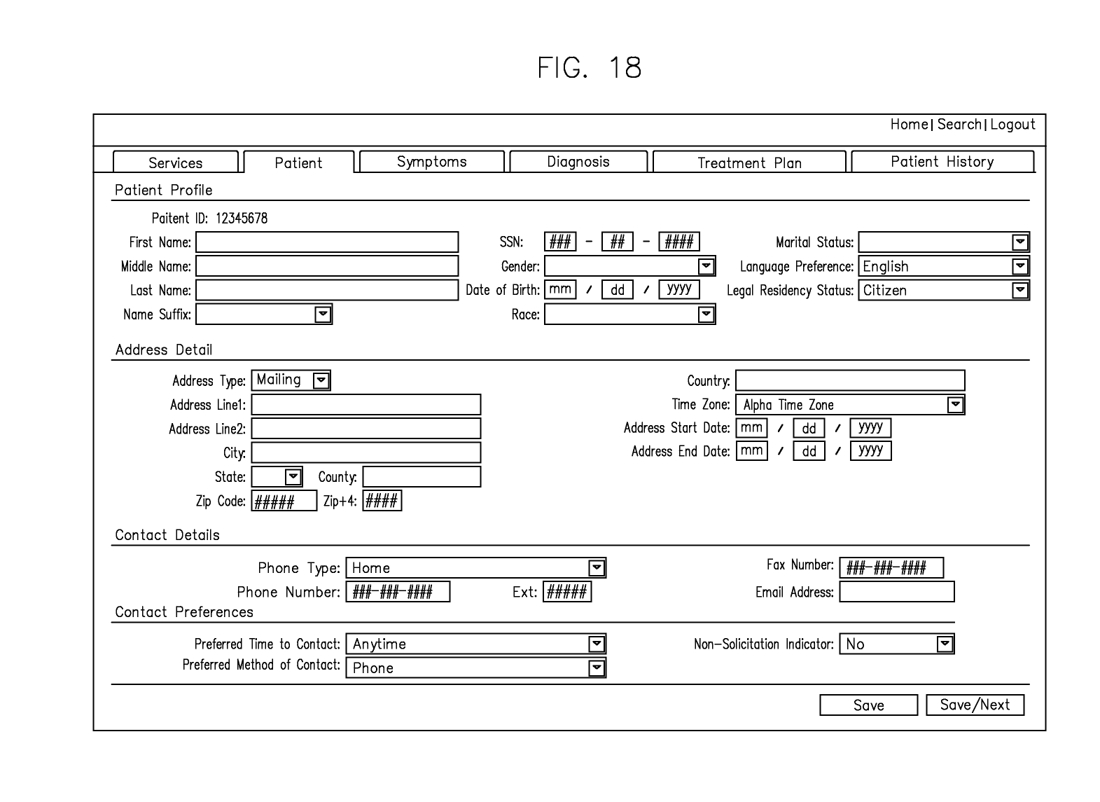

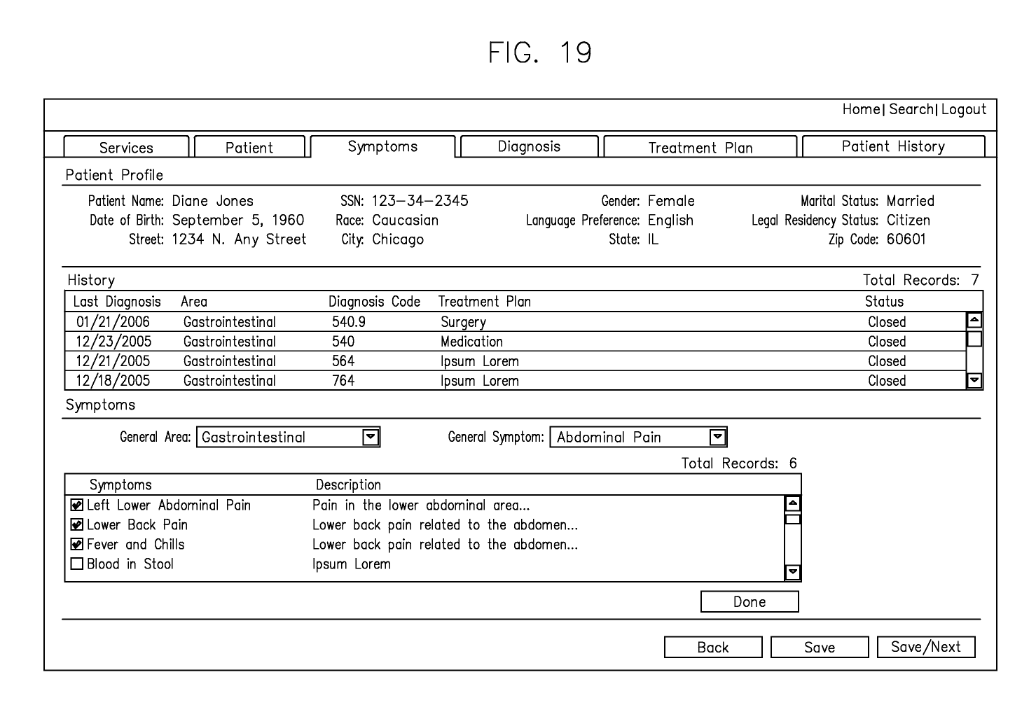

Referring to FIGS. 15-17, an administrator may update or manage CPT® database 27, ICD-9® database 28, and/or EMR diagnosis engine 26. Updating of CPT® database 27 and ICD-9® database 28 typically includes obtaining the latest CPT® or ICD-9 data (e.g., over network 20), loading the data into staging tables, and importing the data to a respective reference table (i.e., in database 27 or 28). Management of EMR diagnosis engine 26 generally includes the initiation of a search of ICD-9® database 28 for an entry of interest and insertion or an update of a treatment plan into EMR diagnosis engine 26 for the corresponding entry.

Referring to FIG. 18-23, a plurality of screenshots give exemplary embodiments of user interface 31 in system 10. Referring specifically to FIG. 18 for example, a patient EMR management screen allows editing and entry of various patient information including name, social security number (SSN), date of birth, language preference, address, phone number, etc.

Referring specifically to FIG. 19, a symptom selection screen gives a patient summary and history along with drop-down boxes to choose a general symptom area and type followed by checkboxes to select specific symptoms.

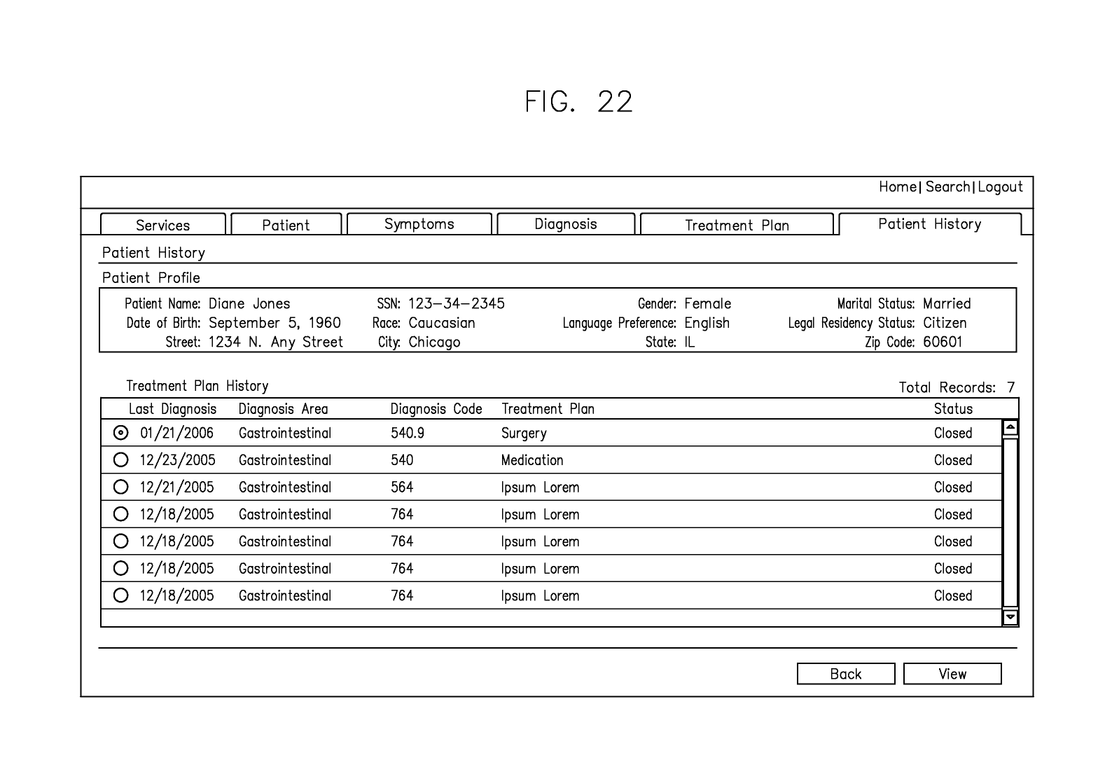

Referring specifically to FIG. 22, a diagnosis review and assessment screen summarizes patient information as well as symptoms and patient history. The screen also provides an area for objective assessment of diagnoses and physical exams or test that have been or will be ordered as well as an assessment of the test result as it relates to the diagnosis.

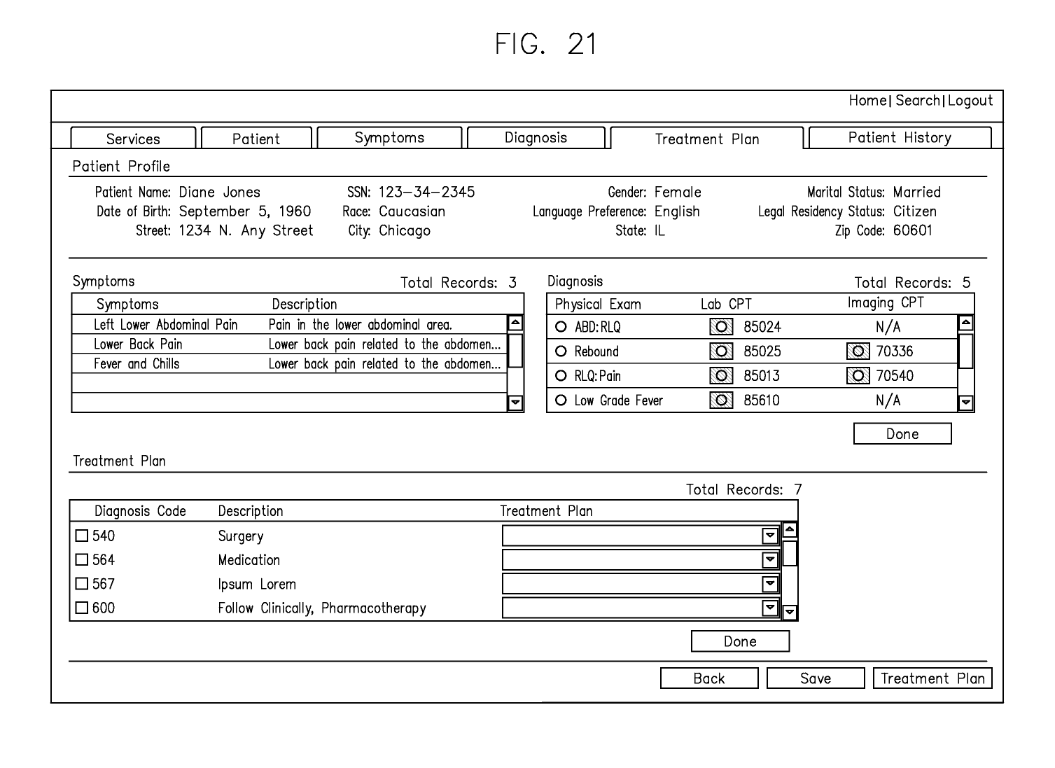

Referring specifically to FIG. 21, a treatment plan review and assessment screen provides a number of diagnosis possibilities to select from based on symptoms and laboratory/imaging tests ordered. The diagnosis may be followed by a number of treatment plan options to select from that correspond to various diagnosis codes.

Referring specifically to FIG. 22, a patient history screen provides details of a patient and his or her associated treatment plan history. Each treatment plan history may individually selected and reviewed more fully.

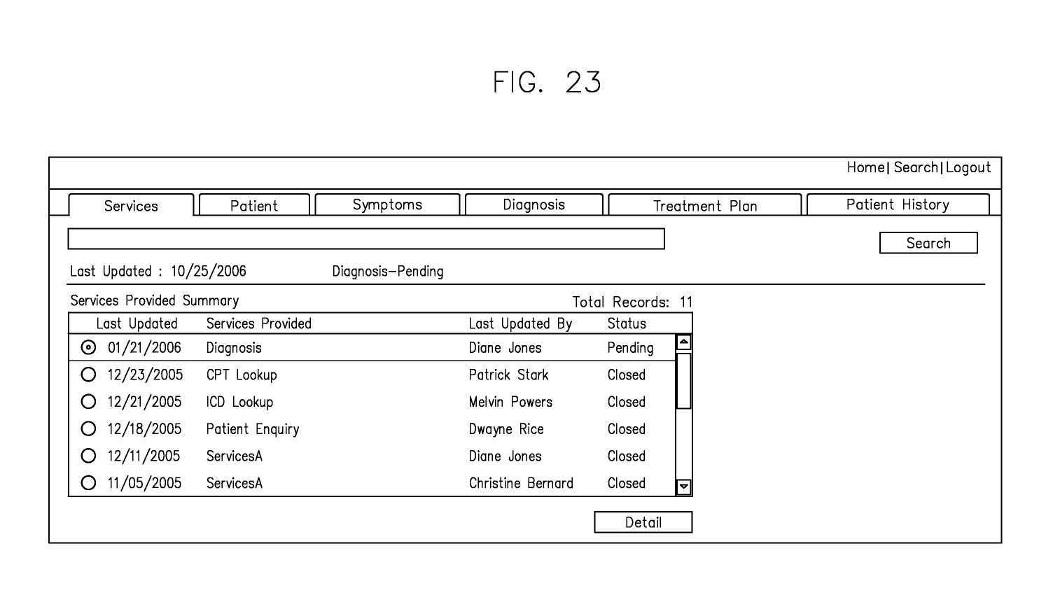

Referring specifically to FIG. 23, a service history screen outlines the services previously provided as well as when, a current status, and who last updated the status.

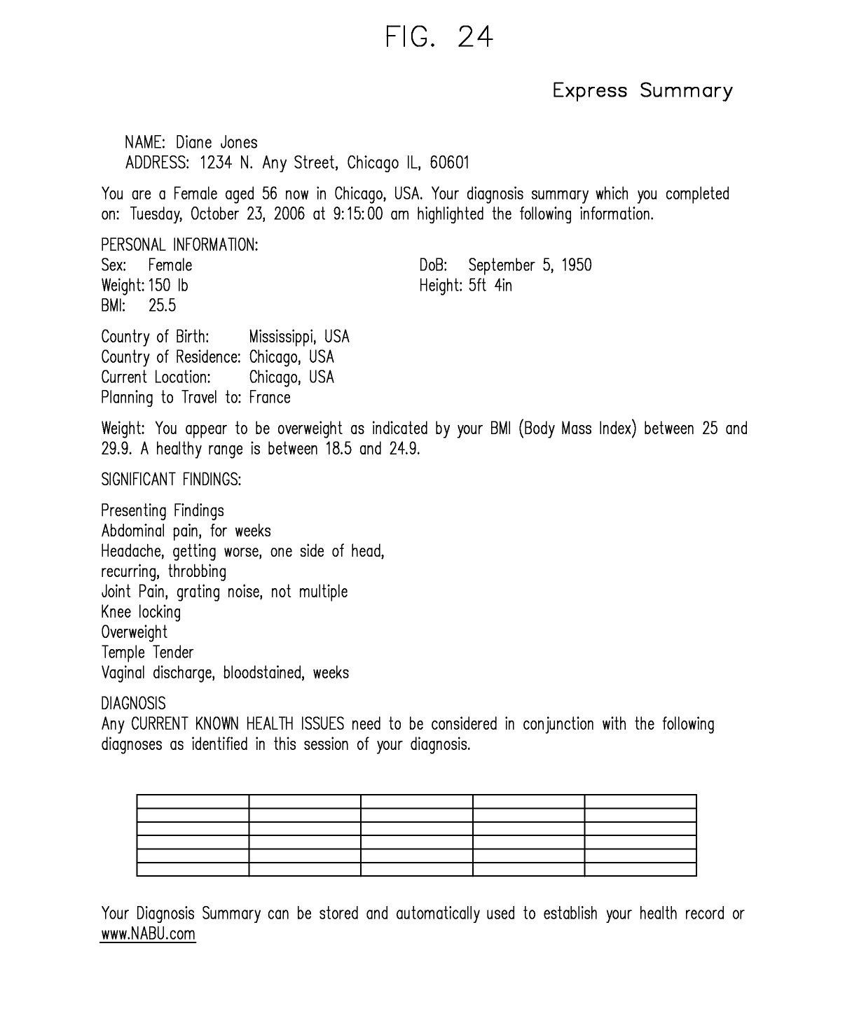

Referring to FIG. 24, an example summary of a treatment plan (that may be emailed or printed as shown in FIG. 4, for example) is shown. This document generally includes patient information, significant findings resulting from physical or lab tests, diagnosis information, and any treatment plan information available.

Attached as Exhibit A to provisional application No. 60/911,241 is a business requirement document that further characterizes other exemplary aspects of system 10 described above. Attached as Exhibit B to provisional application No. 60/911,241 is the “Health Level Seven Implementation Support Guide for HL7 Standard Version 2.3” (Health Level Seven, 1998), which characterizes an exemplary electronic medical record type that may be used in system 10.

### Medical Technique/Process Authorization

It noted that the present disclosure also relates generally to the field of medical techniques and processes and automated authorization of those techniques and processes. While the exemplary embodiments discussed below often refer to techniques and processes used for testing, for example medical imaging. In other exemplary embodiments, the techniques and processes can be techniques and processes used for diagnosis or treatment.

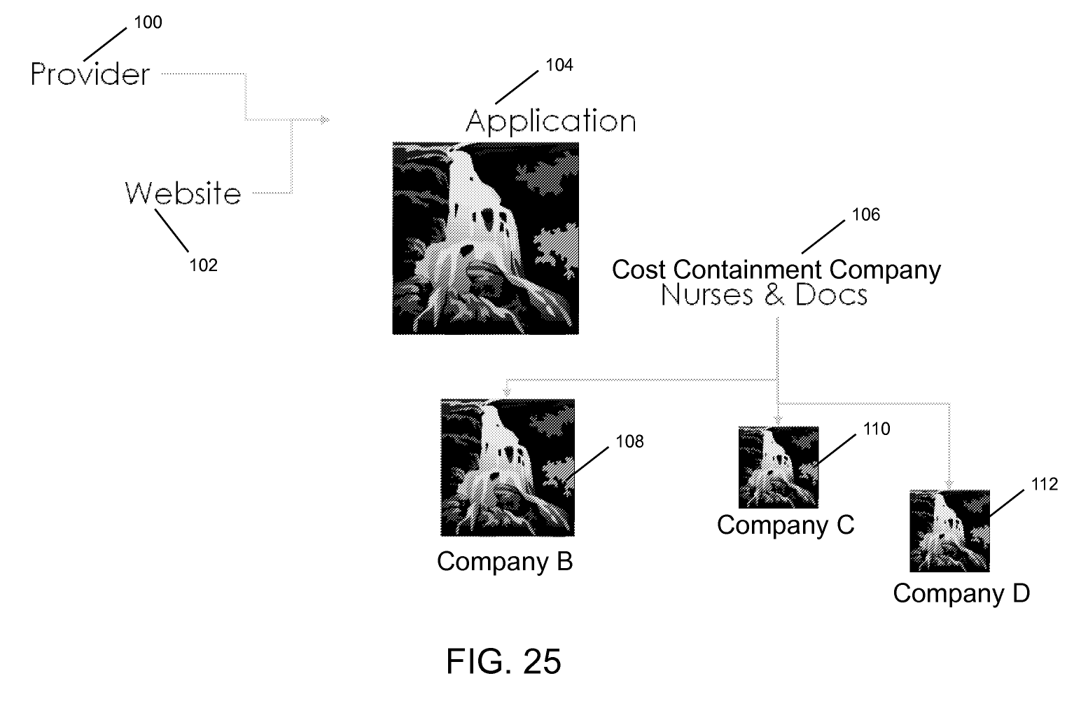

Referring to FIG. 25, according to one exemplary embodiment, a cost containment company may hold contracts with many payors to provide preauthorization and utilization review for a health care provider 100. The company may use a website 102 to document these requests and the website may feed information to a software application 104. Nurses and doctors 106 of the cost containment company may respond to a majority of the requests while the other cases needing a more complex approval process may be distributed to other contracted companies 108, 110, and 112.

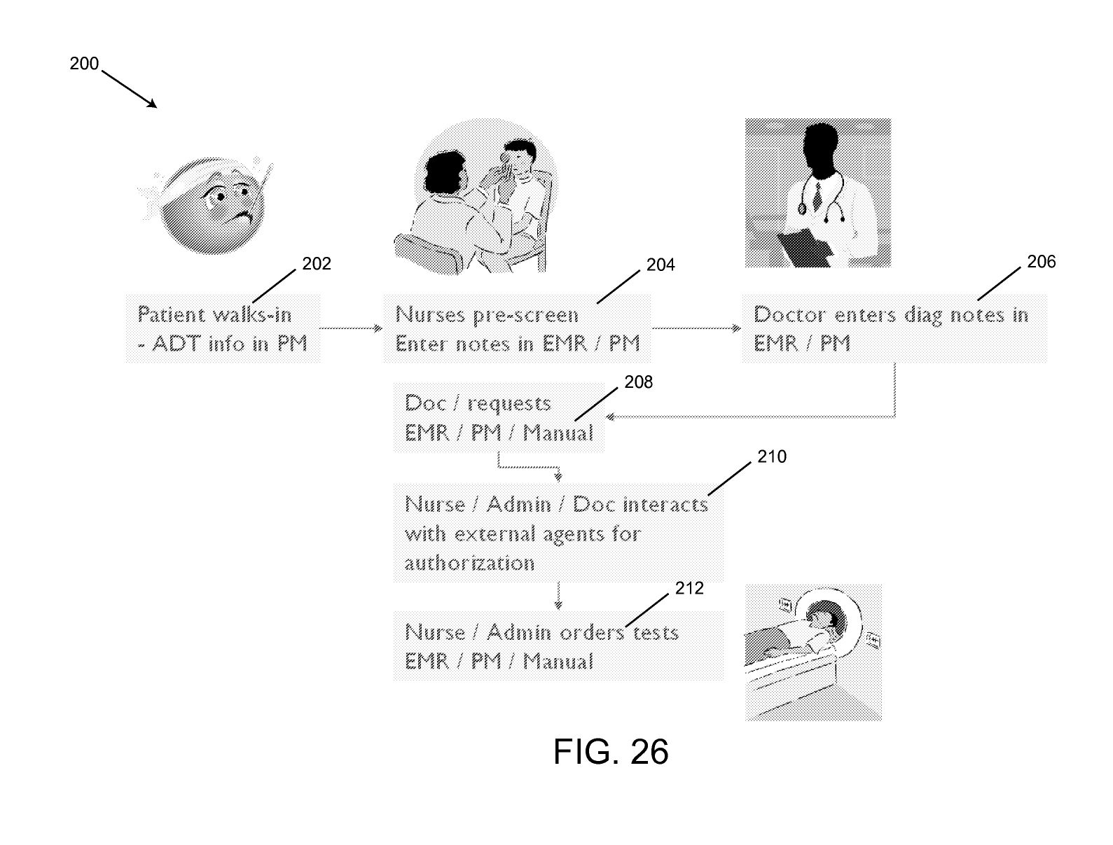

Referring also to FIG. 26, according to an exemplary embodiment, a method 200 at a physicians office includes entering admission, discharge, and transfer (ADT) information into a practice management (PM) system when the patient arrives (step 202). Next, nurses may prescreen the patient and enter notes into an electronic medical record (EMR) or the PM (step 204). When a doctor sees the patient, he or she enters notes into the EMR or PM (step 206). The doctor may then request a test (e.g., a radiology test) by entering data into the EMR or PM or by manually making the request (step 208). In order to gain authorization for the request, the doctor or a nurse or administrator interacts with external or third party agents (e.g., over the phone) (step 210). This interaction is time consuming (e.g., authorization may take up to a week) and often not accurate. Once authorization is received, a nurse or administrator may order the test through the EMR, PM, or by manual entry (step 212).

According to other exemplary embodiments, the doctor may instead or additionally request authorization for processes and techniques other than tests. For example, the doctor may request authorization for treatments, for referral to specialists, for office visits, for diagnoses, etc. The disclosure generally refers to authorization for tests by way of example only and can also refer to authorization for any of the above items or other medical or diagnostic processes and techniques.

As indicated in FIGS. 25 and 26, the cost containment company faces challenges that are also opportunities for cost savings. The cost containment company uses a manual method involving the nurses and physicians to go over the paper manual for imaging guidelines to approve. This manual process can be inaccurate and there is tremendous potential to increase the denial rate and save money to the payors/patients. The cost containment company may also have large cost overhead if it employs full time trained radiology specialists, nurses, and physicians at an American location. These costs may in turn be forwarded to the payor.

The cost containment companies go through a series of questions that are currently not documented by the physicians and require telephonic conversation directly with the physician. Often the physician does not authorize the imaging request and is not aware of it because the front office staff or the nurse may file the request. This may create major lag time in providing a decision on the imaging request. Moreover, the process may be inefficient because it utilizes time of high value resources such as physicians to perform mundane follow-up tasks.

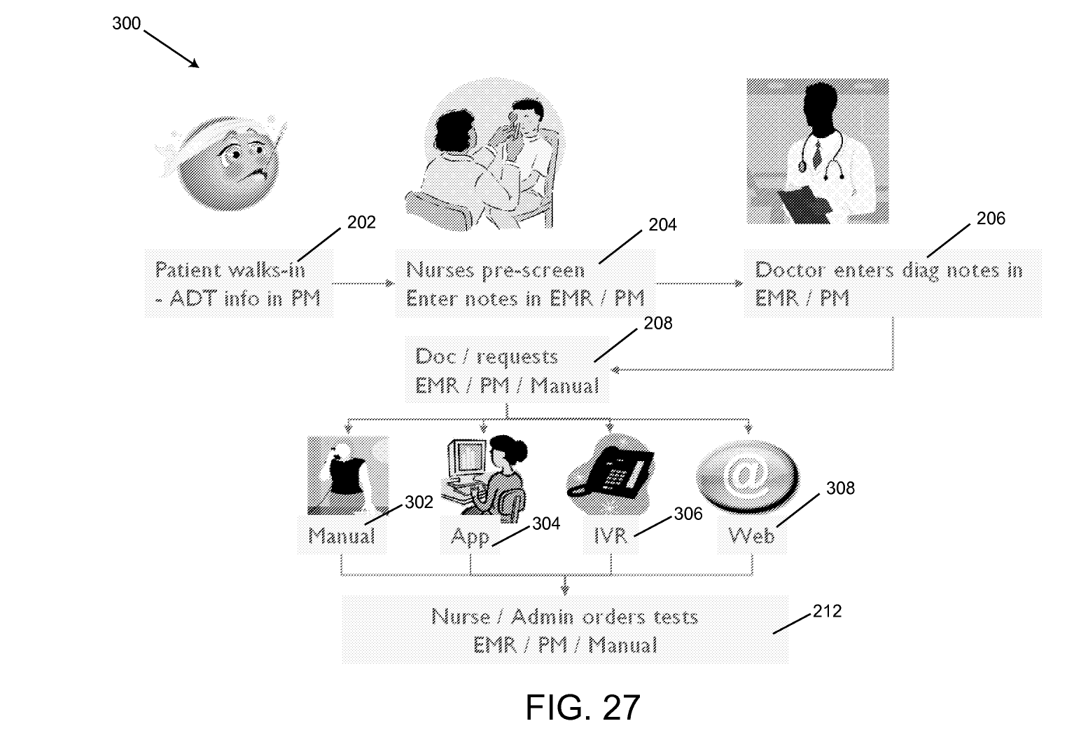

Referring to FIG. 27, according to another exemplary embodiment, a system or method 300 guides a physician's office through a series of tasks and provides instant approval or denial of imaging requests to optimize the current process. Method 300, in addition to saving time, can save payors tremendous costs by reducing the number of requests that go to sub-contracted companies. The system of method 300 may integrate an approval system with a payors online adjudication system to provide physicians with more immediate payment and may increase a physician's motivation to use the system. Up to 80% of patient cases may be automatically approved or denied.

Method 300 includes many of the same steps as method 200, but includes more optimal procedures in place of step 210. The exemplary embodiment of FIG. 3 includes four ways that the physicians office can obtain more instantaneous authorization for a test.

A manual step 302 may be similar to step 210, however, the difference is that the physicians office personnel call and speak to utilization review personnel that can provide instant authorization.

Alternatively, application software or hardware that contains the imaging utilization guidelines as well as the payors contract information may be used (step 304). The application may work in a wizard mode where the user may not be able to reach the request screen if the user has not performed certain mandatory procedures first.

An interactive voice response (IVR) system may also be used (step 306). The IVR is a toll free number that the physicians can call for instant requests and authorization. The IVR system may replicate the functions of the application in step 304.

A web component or browser based software may alternatively be used (step 308)so that the physician office personnel can connect from anywhere. The web software may replicate the functions of the application in step 304.

All four modes of approval may provide the physician with an approval number that is unique and can be reflected in the bills to the payors.

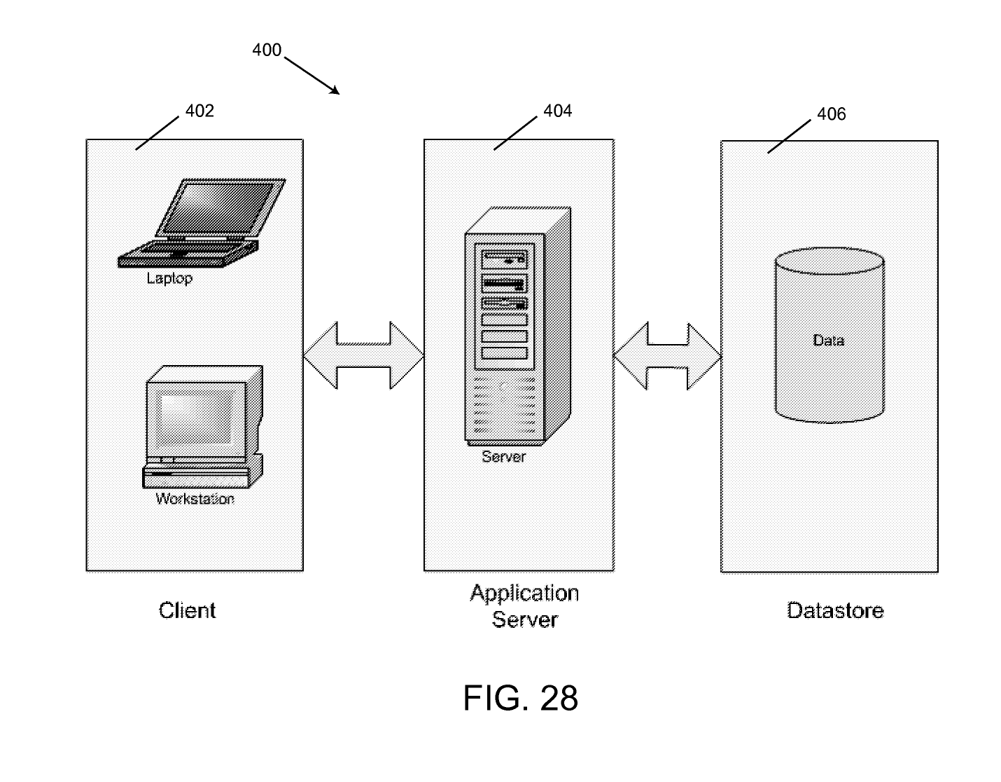

Referring also to FIG. 28, a system 400 may be configured to implement or execute method 300 and particularly step 308 of method 300. System 400 generally includes a client 402 (e.g., a laptop, workstation, or other computing device) that communicates with an application server 404 over a network such as the Internet. Application server 404 is configured to provide the application interface to client computer 402. Based on client 402 requests and/or submissions, application server 404 is configured to communicate with a datastore or database 406. Server 404 may store or retrieve patient, test, diagnosis, or other medical information to or from database 406. It is noted that while a specific network architecture is illustrated, according to other exemplary embodiments, the application may run locally on client computer 402, additional servers may be used, additional databases may be used, and multiple clients may exist. Database 406 may be remotely located from server 404 and client 402 or may be integrated in server 404 or client 402. According to various exemplary embodiments, method 300 and step 308 may be implemented as computer code on computer-readable media and configured for execution by client 402 and/or server 404. According to another exemplary embodiment, method 300 and step 308 may be hardwired on client 402 and/or server 404.

System 400 may also interface with or may include the systems and methods described in expired Provisional U.S. Patent Application 60/911,241 filed Apr. 11, 2007, pending P.C.T. Application PCT/US2008/059656 filed Apr. 8, 2008, and pending U.S. patent Application Ser. No. 12/595,204 filed Apr. 8, 2008, each of which is herein incorporated by reference in its entirety. System 400 may further interface with or may include the systems and method described with reference to FIGS. 1-24. For example, system 400 may interface with or include system 10 illustrated in FIG. 1.

According to various exemplary embodiments, the Application, IVR, and Web components, may include various features, including:

Security features: The application may allow only registered users to login to system 400. The application may provide for lost-password features and may authenticate and record all user interactions.

Patient information: The application may allow the physicians to enter patients demographic information and may allow the physician to enter diagnosis information.

Business logic: Based on the radiology utilization guidelines, the application may generate an interactive questionnaire. Based on the results of the questionnaire, the application may automatically approve or deny the request for imaging. On approval, the application t may generate a unique approval or rejection ID. The application may upload the pre-authorization data to a central server (e.g., server 404) or database (e.g., database 406). Client 402 may allow authorized payors to extract authorization information from server 404.

Deployment features: The application may perform as stand alone software in the physicians office, may be accessed over the Internet, or may be accessed over an interactive voice response system.

Change engine: Authorized users may be able to modify the business logic of the application.

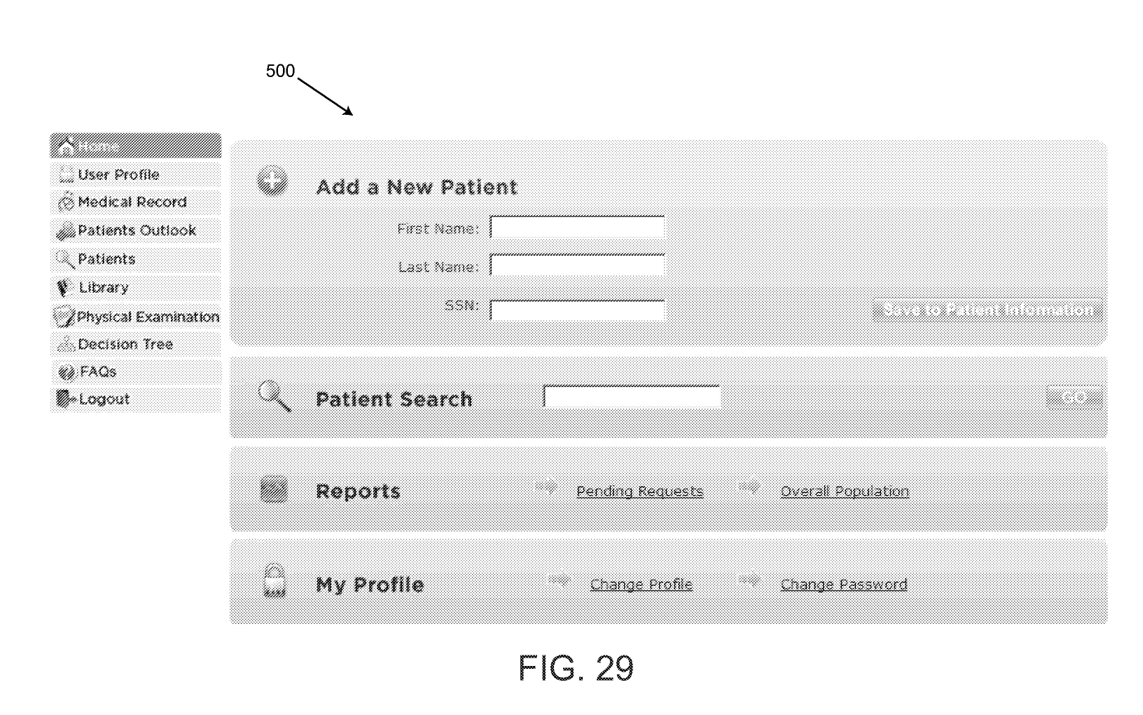

Referring to FIG. 29, a screenshot 500 of a home screen for system 400 (e.g., as displayed on client 402) is illustrated according to an exemplary embodiment. The home screen allows a user to perform various tasks including adding a new patient, searching for or editing existing patient profiles, generating reports, etc.

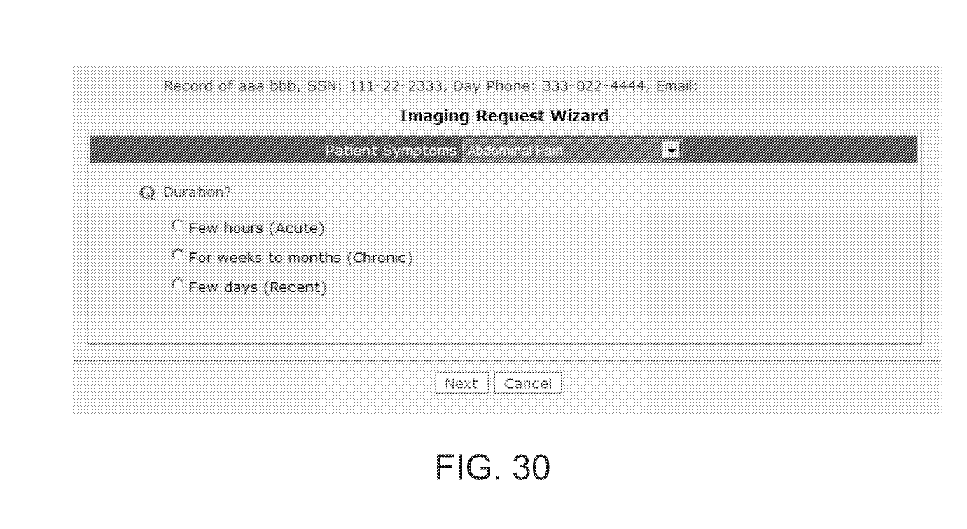

Referring to FIGS. 30-36, according to an exemplary embodiment, for each new or existing patient, a medical professional may add a new instance of a medical issue the patient is having in order to determine tests that are authorized for determining a medical diagnosis. FIGS. 30-36 describe a single example of symptoms a patient may be experiencing, but the disclosure is not limited to only this specific example.

Referring specifically to FIG. 30, a user may select a patient symptom from a drop-down menu. In this case, the user selects the abdominal pain symptom. After selecting the symptom, system 400 provides the user with a questionnaire to gather more information. For example, system 400 may ask the user about the duration of the abdominal pain. In this case, the user selects for weeks to months (Chronic) and then the “Next” button.

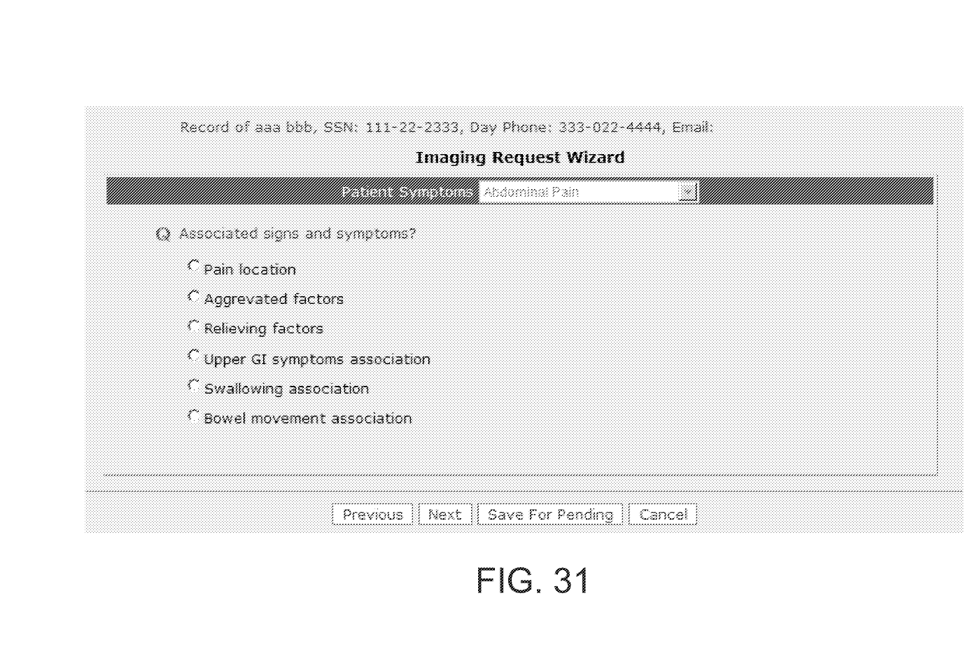

Referring specifically to FIG. 31, system 400 then prompts the user for any associated signs and symptoms. In this case, the patient is having associated upper GI symptoms and the user selects this option. It is noted that at any point, the user may return to the previous screen using the “Previous” button, save the data entered for later using the “Save For Pending” button, or cancel the operation entirely using the “Cancel” button.

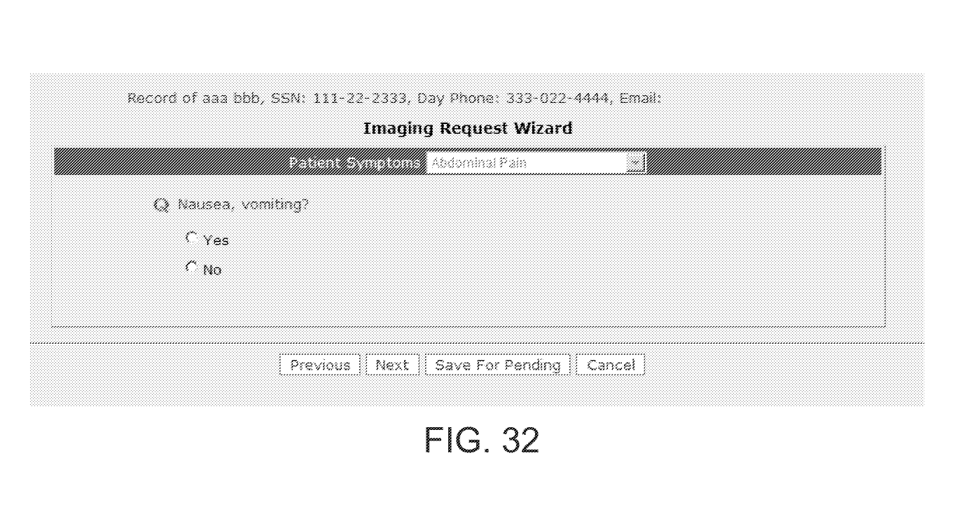

Referring specifically to FIG. 32, system 400 then prompts the user whether there is nausea or vomiting. In this case, the user selects the option indicating that there is nausea or vomiting.

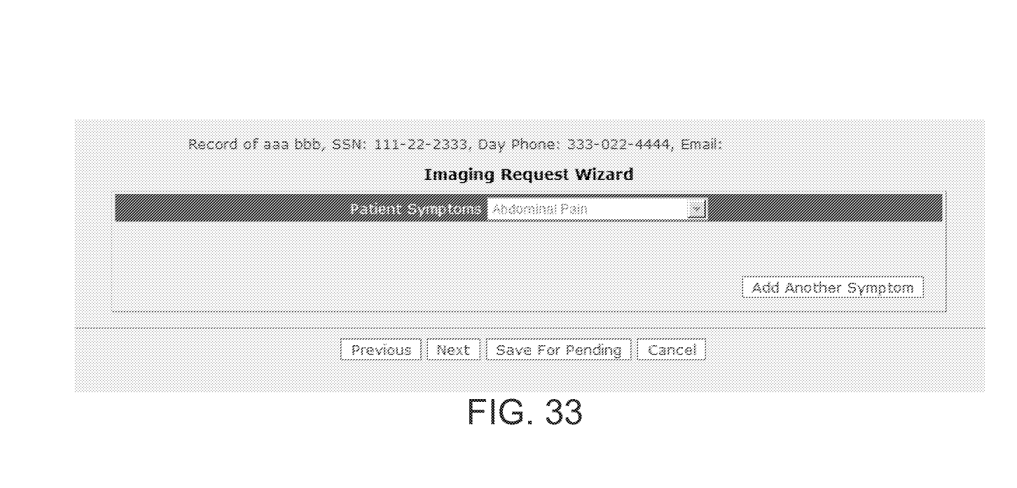

Referring specifically to FIG. 33, system 400 then allows the user to enter any additional symptoms that may be occurring or to continue with the selected symptom or symptoms. In this case, the user continues only with the abdominal pain symptom.

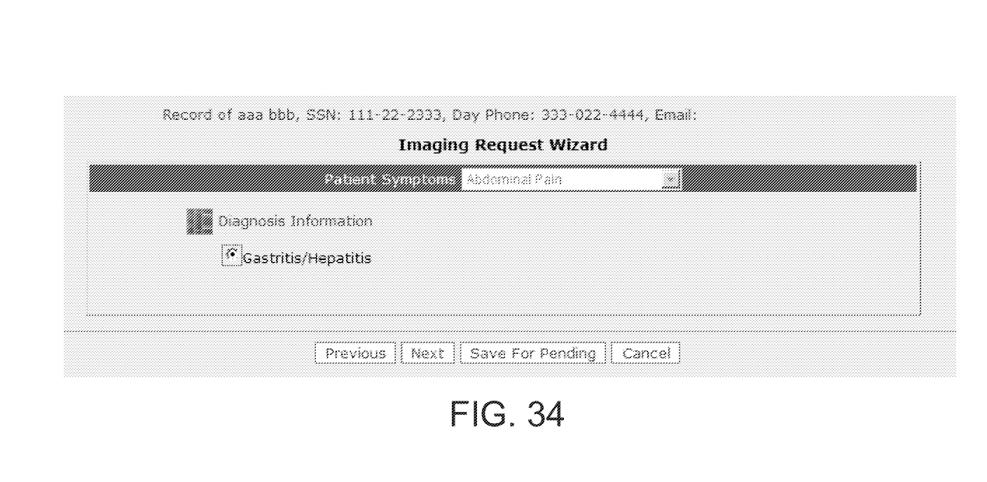

Referring specifically to FIG. 34, based on the questionnaire information, system 400 is able to determine a diagnosis of gastritis/hepatitis. If multiple diagnoses are possible, system 400 displays all of them and the user may select an individual diagnosis for testing.

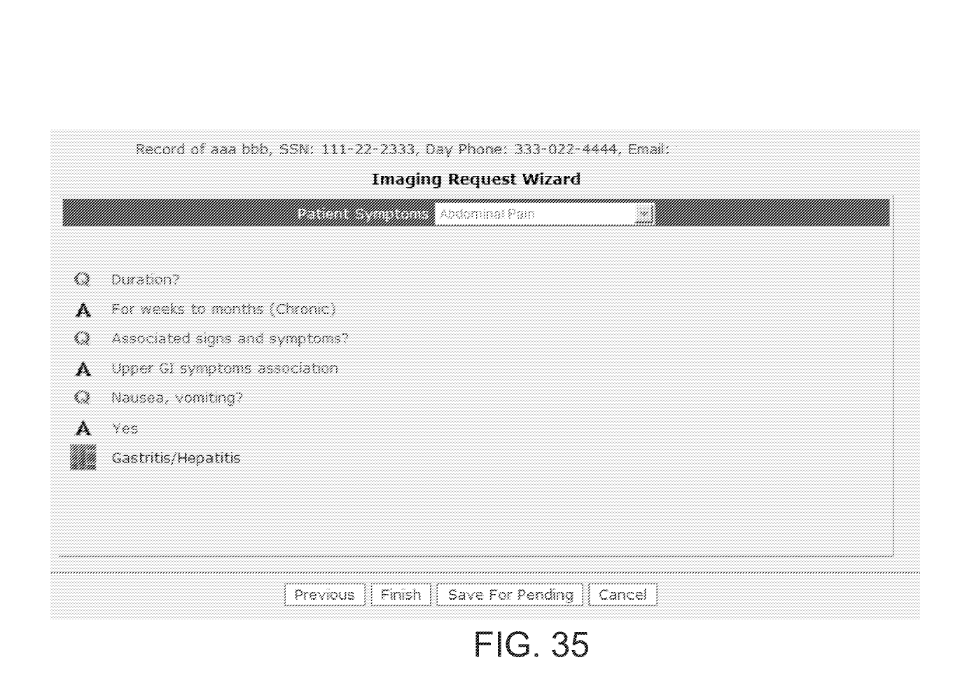

Referring specifically to FIG. 35, after selecting a diagnosis, a summary of the questionnaire questions, answers, and diagnosis that have been selected is displayed so that the user can go back and fix any errors. When confirmed, the user may click “Finish” to proceed.

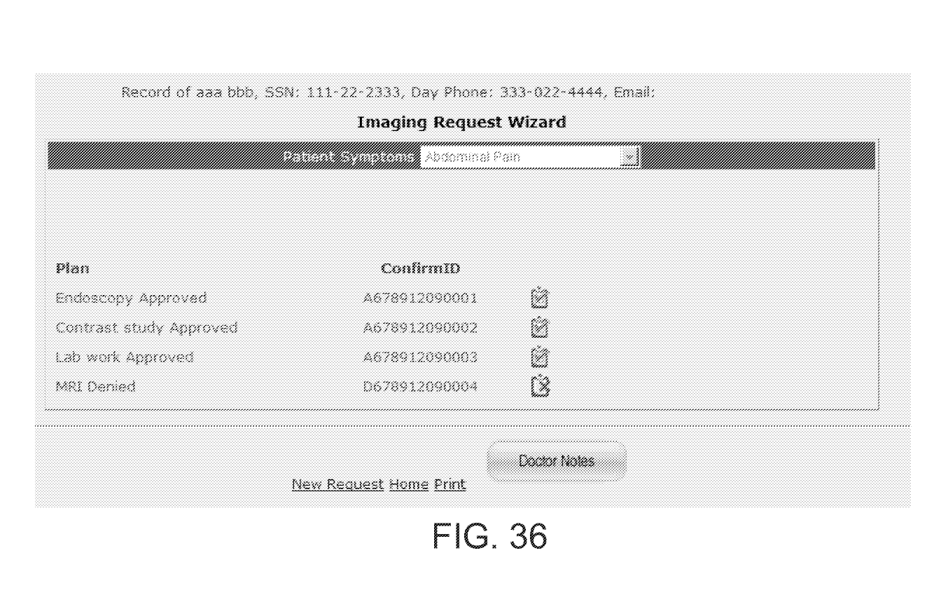

Referring specifically to FIG. 36, once the user is finished, system 400 automatically displays what tests (e.g., radiology tests) are approved or denied based on the associated symptoms and diagnosis. Further, system 400 generates a unique confirmation ID indicating each individual approved or denied test for the patient instance. At this point, the doctor may enter additional notes, enter a new request, print the results, or return to the home page.

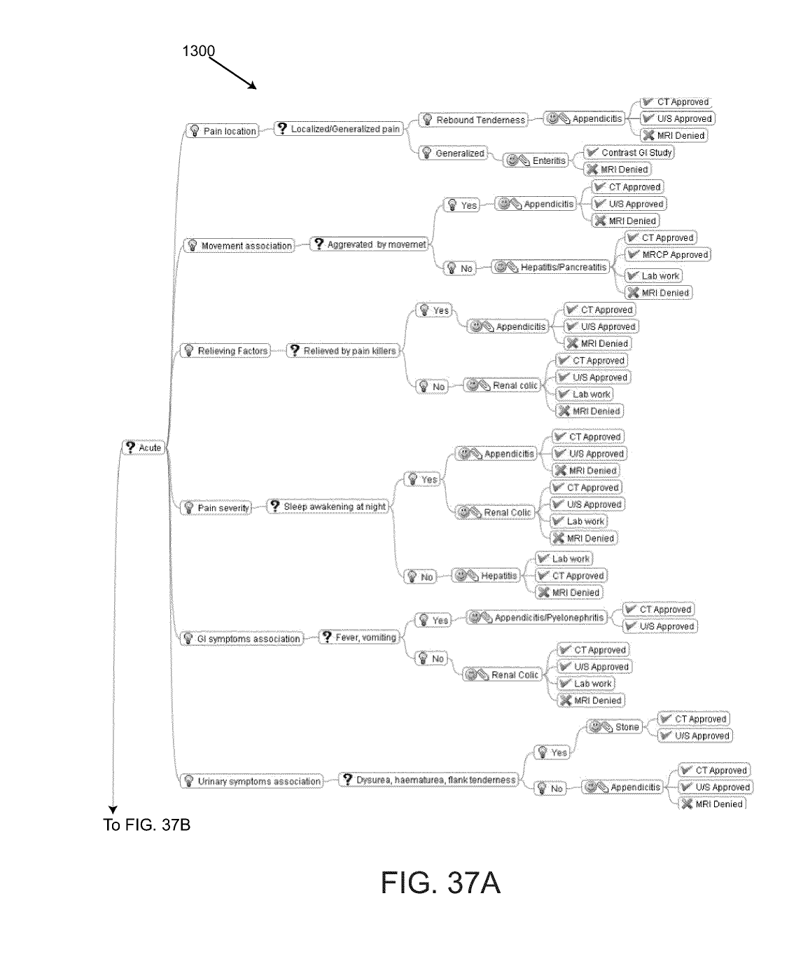

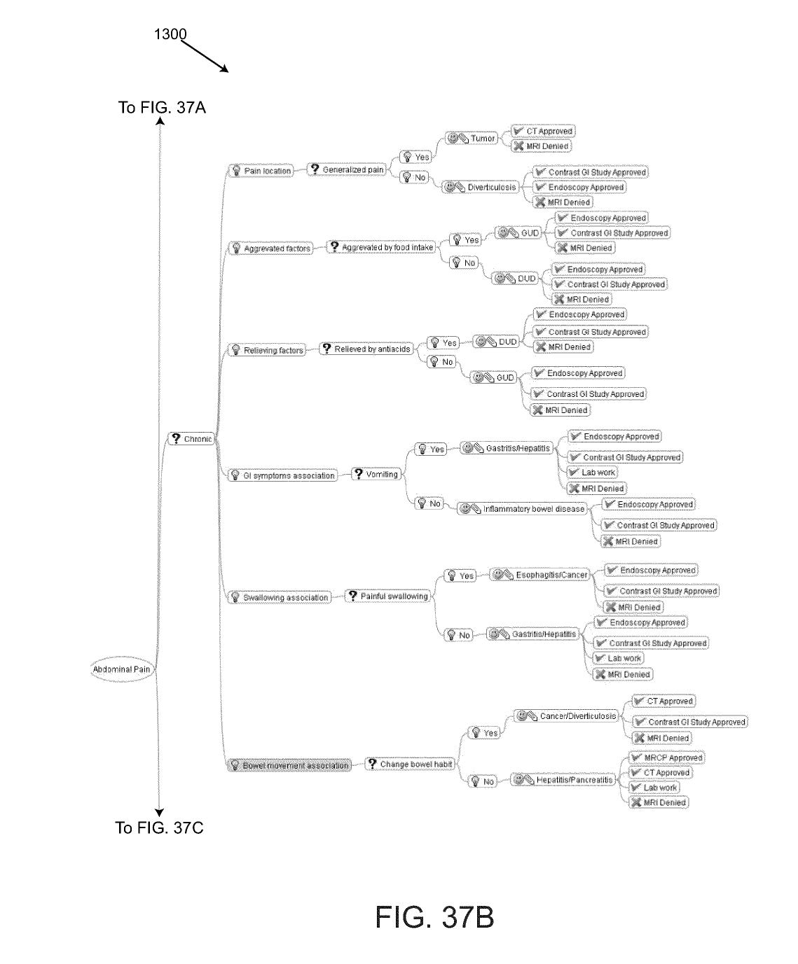

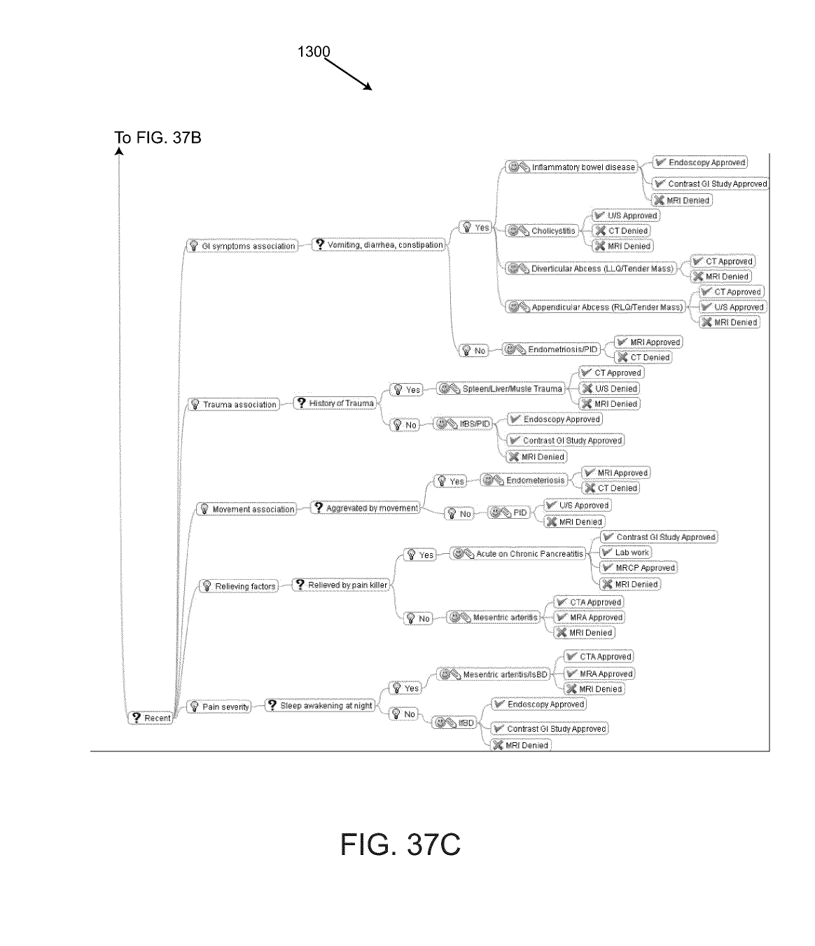

Referring now to FIG. 37, an exemplary decision tree 1300 for the abdominal pain symptom is illustrated according to an exemplary embodiment. Decision tree 1300 provides a causal relationship between the patient symptoms, possible diagnoses, and test choices. System 400 includes such a decision tree for each symptom selectable in the drop-down menu shown in FIG. 30.

According to various exemplary embodiments, further details, features, and characterizations of the systems and methods described above are provided in Exhibits, A, B, C, and D attached to provisional application No. 61/302,843. The Exhibits attached to provisional application No. 61/302,843 include detailed software requirements and descriptions. It is noted that while the Exhibits attached to provisional application No. 61/302,843 describe software solutions for execution on a computer, according to other exemplary embodiments, the software solutions may be embodied as analog and/or digital hardware.

While the exemplary embodiments illustrated in the Figures and described above are presently preferred, it should be understood that these embodiments are offered by way of example only. Accordingly, the present invention is not limited to a particular embodiment, but extends to various modifications that nevertheless fall within the scope of the appended claims. The order or sequence of any processes or method steps may be varied or re-sequenced according to alternative embodiments.

Describing the invention with Figures should not be construed as imposing on the invention any limitations that may be present in the Figures. The present invention contemplates methods, systems and program products on any computer or machine-readable media for accomplishing its operations. The embodiments of the present invention may be implemented using an existing computer processors, or by a special purpose computer processor for an appropriate electronic medical records system, incorporated for this or another purpose or by a hardwired system.

Embodiments within the scope of the present invention may include program products comprising computer or machine-readable media for carrying or having machine-executable instructions or data structures stored thereon. Such computer or machine-readable media can be any available media which can be accessed by a general purpose or special purpose computer or other machine with a processor. By way of example, such computer or machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of computer or machine-readable media. Computer or machine-executable instructions comprise, for example, instructions and data which cause a general purpose computer, special purpose computer, or special purpose processing machines to perform a certain function or group of functions. Software implementations of the present invention could be accomplished with standard programming techniques with rule based logic and other logic to accomplish the various connection steps, processing steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were shown and described in order to explain the principals of the invention and its practical application to enable one skilled in the art to utilize the invention in various embodiments and with various modifications as are suited to the particular use contemplated.

What is claimed is:

1. An automated system for determining authorization or denial of payment for a medical technique or process, comprising:
a user interface configured to receive data related to patient symptoms and diagnosis information;
a database configured to store data related to patient symptoms and diagnosis information; and
a processor configured to automatically determine authorization or denial of the medical technique or process based on data related to patient symptoms and diagnosis information, the data related to patient symptoms and diagnosis information being received from at least one of the user interface and the database, the processor configured to provide an indication of authorization or denial to the user interface.

2. The system of claim 1, wherein the processor determines authorization or denial using a causal decision tree, the processor traversing the decision tree using data related to patient symptoms and diagnosis information to determine authorization or denial.

3. The system of claim 1, wherein the medical technique or process is a technique or process for diagnosis, treatment, or testing.

4. The system of claim 1, wherein the medical technique or process is a medical imaging technique or process.

5. The system of claim 4, wherein the medical imaging technique or process comprises at least one of radiology, radiological sciences, endoscopy, thermography, medical photography and microscopy, electroencephalography, magnetoencephalography, magnetic resonance imaging, nuclear imaging, tomography, and fluoroscopy.

6. The system of claim 1, wherein the processor is executed by a server, the server communicating over a network with at least one of the user interface and the database.

7. The system of claim 6, wherein the database is stored on the server or on another server.

8. The system of claim 1, wherein the user interface is located on a laptop computer, a desktop computer, or a workstation.

9. The system of claim 8, wherein the processor is executed by the laptop computer, desktop computer, or workstation.

10. The system of claim 8, wherein the database is stored on a server or on the laptop computer, desktop computer, or workstation.

11. An automated method for determining authorization or denial of payment for a medical technique or process, comprising:
receiving data related to patient symptoms and diagnosis information at a user interface;
storing data related to patient symptoms and diagnosis information on a database;
automatically determining authorization or denial of the medical technique or process based on data related to patient symptoms and diagnosis information using a processor, the data related to patient symptoms and diagnosis information being received from at least one of the user interface and the database; and
providing an indication of authorization or denial from the processor to the user interface.

12. The method of claim 11, wherein the processor determines authorization or denial using a causal decision tree, the processor traversing the decision tree using data related to patient symptoms and diagnosis information to determine authorization or denial.

13. The method of claim 11, wherein the medical technique or process is a technique or process for diagnosis, treatment, or testing.

14. The method of claim 11, wherein the medical technique or process is a medical imaging technique or process.

15. The method of claim 14, wherein the medical imaging technique or process comprises at least one of radiology, radiological sciences, endoscopy, thermography, medical photography and microscopy, electroencephalography, magnetoencephalography, magnetic resonance imaging, nuclear imaging, tomography, and fluoroscopy.

16. The method of claim 11, wherein the processor is executed by a server, the server communicating over a network with at least one of the user interface and the database.

17. The method of claim 16, wherein the database is stored on the server, on another server, on a laptop computer, on a desktop computer, or on a workstation.

18. The method of claim 11, wherein the user interface is located on a laptop computer, a desktop computer, or a workstation.

19. The method of claim 11, wherein the processor is executed by a laptop computer, desktop computer, or workstation.

20. An automated system for determining authorization or denial of payment for a medical technique or process, comprising:
means for receiving data related to patient symptoms and diagnosis information;
means for storing data related to patient symptoms and diagnosis information;
means for automatically determining authorization or denial of the medical technique or process based on data related to patient symptoms and diagnosis information, the data related to patient symptoms and diagnosis information being received from at least one of the user interface and the database; and
means for providing an indication of authorization or denial.
